(19) United States
(12) Patent Application Publication
(10) Pub. No.: US 2013/0137476 A1
(43) Pub. Date: May 30, 2013

(54) TERMINAL APPARATUS

(71) Applicants: Hideki Kawaguchi, Kobe-shi (JP); Tatsuki Kubo, Kobe-shi (JP)

(72) Inventors: Hideki Kawaguchi, Kobe-shi (JP); Tatsuki Kubo, Kobe-shi (JP)

(73) Assignee: FUJITSU TEN LIMITED, Kobe-shi (JP)

(21) Appl. No.: 13/603,907

(22) Filed: Sep. 5, 2012

(30) Foreign Application Priority Data
Nov. 28, 2011 (JP) 2011-259613

(51) Int. Cl. H04W 4/08; G09G 5/00

(52) U.S. Cl. 455/519; 345/634

(57) ABSTRACT

A mobile terminal apparatus implements, via a server apparatus, group communication that is communication among members belonging to a same group. The mobile terminal apparatus generates a group selection image used for selecting an objective group for which the group communication is implemented. The group selection image includes: a selection candidate image indicating one or more candidate groups that are selection candidates for the objective group; and a location image including a map image and an icon image indicating a member belonging to one candidate group among the one or more candidate groups, at a location corresponding to positioning information of the member, on the map image.

### BACKGROUND OF THE INVENTION

1. Field of the Invention

The invention relates to a technology for communication among members who belong to a same group.

2. Description of the Background Art

Conventionally, group communication systems, in which a member belonging to a predetermined group, such as “friend” and “family member,” constituted by users communicate with other members of the group by using a mobile terminal apparatus, such as smartphone, have been known.

A type of the group communication systems recently provided allows members belonging to a same group to share positioning information of the members.

For example, in a communication system disclosed in Japanese Patent Application Laid-open Publication No. 2009-055564, mobile terminal apparatuses of individual members belonging to a predetermined group transmit positioning information of an own apparatus to a predetermined server by using Global Positioning System (GPS) function. Then the server generates a map image including icons indicating locations of the members, based on the positioning information received from the mobile terminal apparatuses, and then transmits the map image to the mobile terminal apparatuses of the members. Thus, the members who participate in the group communication can enjoy conversation with knowledge of locations of the other members.

However, the conventional technology mentioned above has a problem that the members cannot understand the locations of the other members belonging to the group before participating in the group communication.

In other words, even if a user desires to determine participation in group communication after checking locations of other members, the user cannot know the locations of the other members unless participating in the group communication.

Therefore, a user who only desires to know a location of another member, for example, may participate in the group communication at one point and may end the participation immediately. Such an act gives not only inconvenience to the user but possibly also an unpleasant impression to other members.

### SUMMARY OF THE INVENTION

According to one aspect of the invention, a terminal apparatus includes: communication part that implements, via a server apparatus, group communication that is communication among members belonging to a same group; and an image generator that generates a group selection image used for selecting an objective group for which the group communication is implemented. The group selection image includes: a selection candidate image indicating one or more candidate groups that are selection candidates for the objective group; and a location image including a map image and an icon image indicating a member belonging to one candidate group among the one or more candidate groups, at a location corresponding to positioning information of the member, on the map image.

Thus, a user can understand the location of the member belonging to the one candidate group before participating in the group communication.

According to another aspect of the invention, a terminal apparatus implements, via a server apparatus, group communication that is communication among members belonging to a same group. The terminal apparatus includes: a first display controller that displays, on a display, a list of one or more candidate groups that are selection candidates for an objective group for which the group communication is implemented; a second display controller that displays, on the display, a map image including an icon image indicating a location of a member belonging to one candidate group temporarily selected by a user, from amongst the one or more candidate groups; and an instruction part that, when the objective group is selected from amongst the one or more candidate groups, instructs the server apparatus to start the group communication for the selected objective group.

Thus, the user can understand the location of the member belonging to the one candidate group before participating in the group communication.

Therefore, an object of the invention is to understand a location of a member belonging to one of candidate groups that are selection candidates for an objective group.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a diagram showing an exemplar system configuration of group communication in a first embodiment;

FIG. 2 is a diagram showing equipment disposed in a vehicle;

FIG. 3 is a bloc diagram showing configurations of a mobile terminal apparatus and a vehicle-mounted apparatus;

FIG. 4A is a diagram showing an example of user management information;

FIG. 4B is a diagram showing an example of group management information:

FIG. 5A is a diagram showing an example displayed on a touch screen panel;

FIG. 5B is a diagram showing an example displayed on the touch screen panel;

FIG. 5C is a diagram showing an example displayed on the touch screen panel;

FIG. 5D is a diagram showing an example displayed on the touch screen panel;

FIG. 5E is a diagram showing an example displayed on the touch screen panel;

FIG. 5F is a diagram showing an example displayed on the touch screen panel;

FIG. 5G is a diagram showing an example displayed on the touch screen panel;

FIG. 5H is a diagram showing an example displayed on the touch screen panel;

FIG. 6 is a flowchart showing a procedure of an application boot process;

FIG. 7 is a flowchart showing a procedure of a group selection process;

FIG. 8 is a flowchart showing a procedure of a group talk transmission process;

FIG. 9 is a flowchart showing a procedure of a group talk reception process;

FIG. 10 is a flowchart showing a procedure of a terminal side participation end process;

FIG. 11 is a flowchart showing a procedure of a server side participation end process;

FIG. 12 is an exemplar during-talk image in a second embodiment;

FIG. 13 is a flowchart showing a procedure of a shared mobile terminal registration process;

FIG. 14 is a flowchart showing a procedure of a member changeover process;

FIG. 15 illustrates an exemplar image of a group selection image in a third embodiment;

FIG. 16 is a flowchart showing a procedure of a terminal side grouping process; and

FIG. 17 is a flowchart showing a procedure of a server side grouping process.

### DESCRIPTION OF THE EMBODIMENTS

Embodiments are hereinafter explained in detail with reference to the attached drawings. However, the invention is not limited to examples in the embodiments described below.

### 1. First Embodiment

<1-1. System Outline>

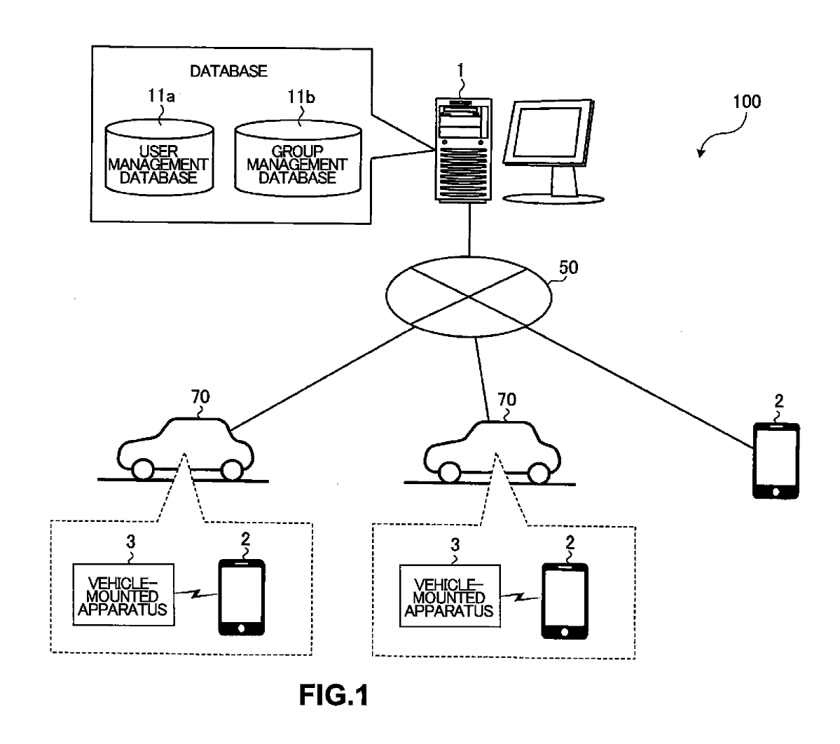

First, a system configuration of a group communication system in a first embodiment is explained with reference to FIG. 1. FIG. 1 is a diagram showing an exemplar system configuration of the group communication system in the first embodiment. The group communication system is used for group communication that is communication among members belonging to a same group.

An example explained hereinafter is a case of voice group communication (hereinafter referred to as a “group talk”). However, the group communication using the group communication system disclosed in this application is not limited to a voice group talk, and may be group communication in any form such as text group communication. Moreover, a vehicle-mounted apparatus is hereinafter explained as an example of an information displaying apparatus. However, the information displaying apparatus may be an apparatus other than the vehicle-mounted apparatus.

As shown in FIG. 1, a group communication system 100 in the first embodiment includes a server 1, a mobile terminal apparatus 2 and a vehicle-mounted apparatus 3. In the group communication system 100, talk data that is communication data relating to the group talk among the mobile terminal apparatuses 2 of members belonging to a predetermined group, is shared.

The server 1 is a center apparatus that provides group talk service. The server 1 is a general computer, such as a personal computer, and includes a controller such as a central processing unit (CPU). The controller of the server 1 implements various processes relating to the group talk in accordance with a request from the mobile terminal apparatus 2. Details of these processes are described later. The controller of the server 1 functions, for example, as a transmitting means that transmits positioning information and as a data processing means that processes the talk data relating to the group talk.

Moreover, the server 1 includes a data base having a user management database 11a and a group management database 11b.

The user management database 11a is used for managing information about users joining the group talk service. The user management database 11a stores information such as a user ID, a user name, and a current location of a user as user management information.

Moreover, the group management database 11b is used for managing information about a group constituted by the users. The group management database 11b stores information such as a group ID, a group name, and the user IDs belonging to the group, as group management information.

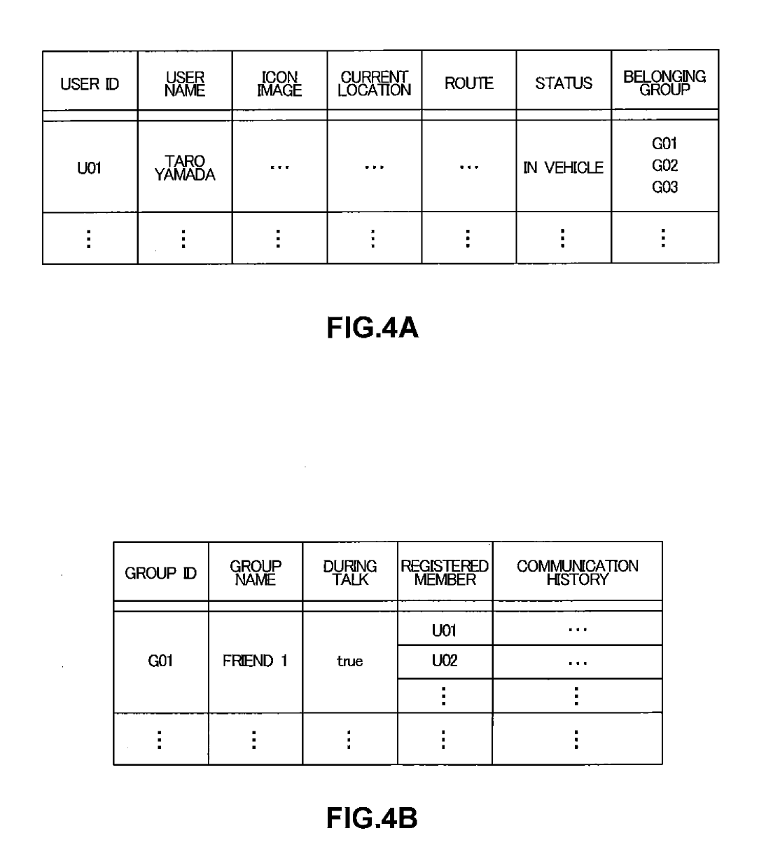

Details of the user management information and the group management information are described later with reference to FIG. 4A and FIG. 4B.

The mobile terminal apparatus 2 is communicably connected with the server 1 and is used for the group talk among the plural mobile terminal apparatuses 2 of the members belonging to the same group. Concretely, the mobile terminal apparatus 2 is, for example, a smartphone or a mobile phone, and is connected to the server 1 via a network 50 such as the Internet and wireless communication. Moreover, the mobile terminal apparatus 2 is connected to the vehicle-mounted apparatus 3 via Near Field Communication such as Wi-Fi (registered trademark) and Bluetooth (registered trademark).

The vehicle-mounted apparatus 3 is mounted on a vehicle 70 and is an information displaying apparatus used in the vehicle 70. Concretely, the vehicle-mounted apparatus 3 implements only basic functions such as a displaying function, an audio playback function, and a communication function with the mobile terminal apparatus 2, but becomes multifunctional by collaborating with the mobile terminal apparatus 2. Moreover, the vehicle-mounted apparatus 3 is not limited to the vehicle-mounted apparatus mentioned above but may include functions (e.g. a navigation function) other than the basic functions mentioned above.

Since the group communication system 100 in the first embodiment is configured as described above, the members belonging to the same group can enjoy the voice group talk with the other members, via the vehicle-mounted apparatus 3 and the mobile terminal apparatus 2.

Moreover, the mobile terminal apparatus 2 may communicate with the vehicle-mounted apparatus 3 via Near Field Communication using a wireless communication standard, such as ZigBee (registered trademark), other than the wireless communication methods mentioned earlier. Furthermore, the communication between the mobile terminal apparatus 2 and the vehicle-mounted apparatus 3 may be implemented by wire communication.

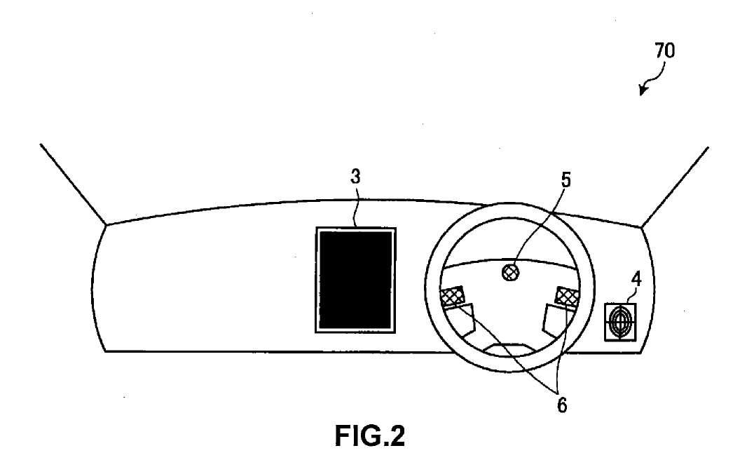

Next explained, with reference to FIG. 2, is equipment disposed in the vehicle 70, such as the vehicle-mounted apparatus 3. FIG. 2 is a diagram showing equipment disposed in the vehicle 70. As shown in FIG. 2, the vehicle 70 is provided with the vehicle-mounted apparatus 3, an authentication apparatus 4, a microphone 5, and a speaker 6, etc.

The authentication apparatus 4 authenticates a user who gets in the vehicle 70. Concretely, the authentication apparatus 4 implements a process of acquiring a user ID from the mobile terminal apparatus 2 by using Near Field Communication such as Radio Frequency Identification (RFID) and of transmitting the acquired user ID to the vehicle-mounted apparatus 3.

Here, the user ID acquired by the authentication apparatus 4 is unique identification information (UID) of the mobile terminal apparatus 2. However, the user ID may be identification information other than UID.

The microphone 5 is a voice inputting part that acquires voice of the user as voice data. The voice data acquired by the microphone 5 is transmitted to the vehicle-mounted apparatus 3. Moreover, the speaker 6 is a voice outputting part that outputs voice based on the voice data received from the vehicle-mounted apparatus 3.

Here, the microphone 5 and the speaker 6 are disposed on a steering wheel. However, the microphone 5 and the speaker 6 may be disposed on a place other than the steering wheel. For example, the speaker 6 may be disposed on a ceiling, a door, a front panel, etc. in the vehicle 70.

The vehicle-mounted apparatus 3 is disposed on a center of the front panel. In other words, the vehicle-mounted apparatus 3 is disposed diagonally forward left from a driver. However, a place where the vehicle-mounted apparatus 3 is disposed is not limited to the place mentioned above but may be disposed diagonally forward right from the driver or in a place other than on the front panel.

Moreover, equipment other than the equipment shown in FIG. 2 may be provided in the vehicle 70. For example, a camera that captures surroundings or a cabin of the vehicle 70 may be provided in the vehicle 70.

<1-2. Apparatus Configuration>

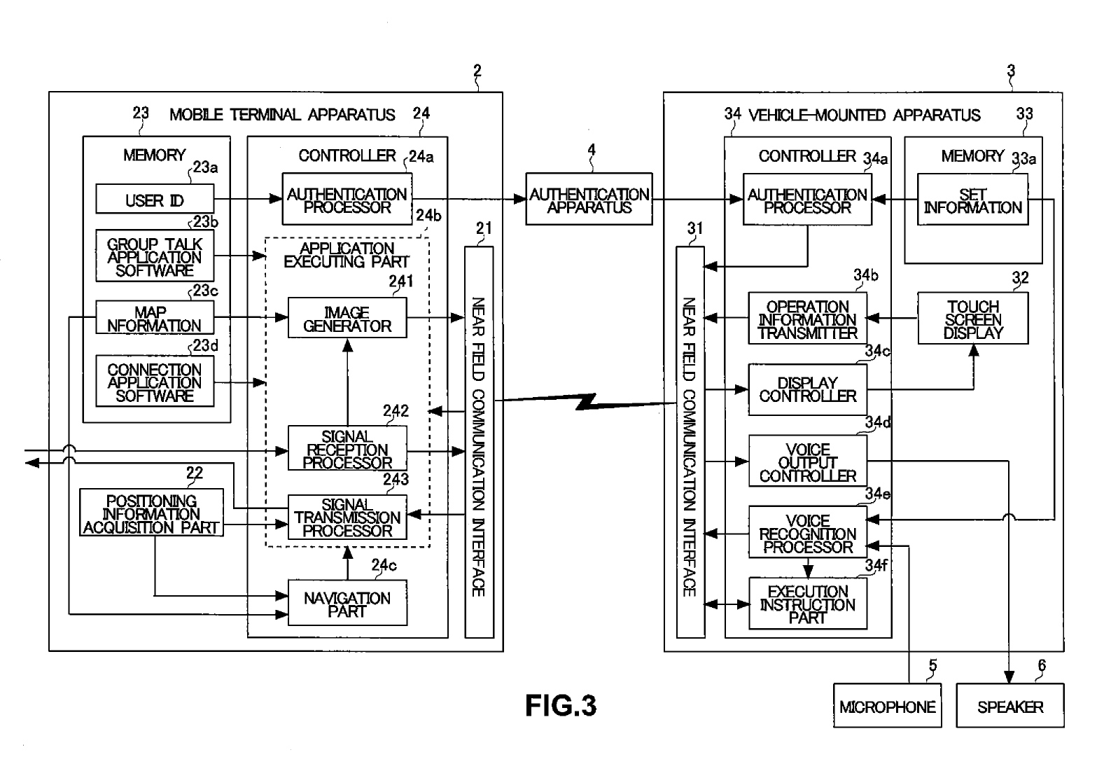

Next, configurations of the mobile terminal apparatus 2 and the vehicle-mounted apparatus 3 are explained with reference to FIG. 3. FIG. 3 is a bloc diagram showing the configurations of the mobile terminal apparatus 2 and the vehicle-mounted apparatus 3. FIG. 3 only illustrates components necessary to explain characteristics of the mobile terminal apparatus 2 and the vehicle-mounted apparatus 3, and descriptions of general components are omitted.

The mobile terminal apparatus 2 includes a near field communication interface 21, a positioning information acquisition part 22, a memory 23 and a controller 24. Moreover, the memory 23 stores a user ID 23a, group talk application software 23b, map information 23c, and vehicle-mounted apparatus connection application software 23d. Moreover, the controller 24 includes an authentication processor 24a, an application executing part 24b, and a navigation part 24c. Furthermore, the application executing part 24b includes an image generator 241, a signal reception processor 242, and a signal transmission processor 243.

The vehicle-mounted apparatus 3 includes a Near Field Communication interface 31, a touch screen display 32, a memory 33, and a controller 34. Moreover, the memory 33 stores set information 33a. Furthermore, the controller 34 includes an authentication processor 34a, an operation information transmitter 34b, a display controller 34c, a voice output controller 34d, a voice recognition processor 34e, and an execution instruction part 34f.

As shown in FIG. 3, the mobile terminal apparatus 2 includes the vehicle-mounted apparatus connection application software 23d for a cooperative operation with the vehicle-mounted apparatus 3. Moreover, the vehicle-mounted apparatus 3 includes a connected operation function for the cooperative operation with the mobile terminal apparatus 2. Thus, the cooperative operation can be performed. For example, while image data generated by using various applications is transmitted from the mobile terminal apparatus 2 to the vehicle-mounted apparatus 3 and is displayed on the touch screen display 32 of the vehicle-mounted apparatus 3, information such as operation information that indicates details of an operation performed with the touch screen display 32, etc. are transmitted from the vehicle-mounted apparatus 3 to the mobile terminal apparatus 2, and the mobile terminal apparatus 2 implements a process in accordance with the operation information.

The vehicle-mounted apparatus connection application also collaborates with an application other than the group talk application. Thus, the application other than the group talk application can be used via the touch screen display 32 or a hard switch, not illustrated, of the vehicle-mounted apparatus 3. The vehicle-mounted apparatus connection application has an intermediate character between an operation system (OS) and an application.

First, the configuration of the mobile terminal apparatus 2 is explained. The near field communication interface 21 is a communication device for Near Field Communication with the vehicle-mounted apparatus 3. Moreover, the positioning information acquisition part 22 is, for example, a global positioning system (GPS) receiver. The positioning information acquisition part 22 acquires the positioning information provided by positioning satellites and transmits the acquired positioning information to the application executing part 24b and/or the navigation part 24c.

The memory 23 is a storage device such as a nonvolatile memory and a hard disc drive, and stores the user ID 23a, the group talk application software 23b, the map information 23c, and the vehicle-mounted apparatus connection application software 23d.

The user ID 23a is, for example, the UID of the mobile terminal apparatus 2. The user ID is not limited to the UID, but may be an ID set by a user arbitrarily or may be an ID automatically assigned by the server 1.

The group talk application software 23b is used for implementing the group talk service provided by the server 1. The map information 23c may be stored in the memory 23 in advance, or only necessary map information may be downloaded from a service center having the map information. The vehicle-mounted apparatus connection application software 23d is used for implementing the cooperative operation with the vehicle-mounted apparatus 3. The vehicle-mounted apparatus connection application software 23d can be downloaded, for example, from the server 1.

The controller 24 controls the whole mobile terminal apparatus 2, and includes the authentication processor 24a, the application executing part 24b, and the navigation part 24c. Moreover, the controller 24 also implements a process of establishing a communication link via Near Field Communication with the vehicle-mounted apparatus 3 by using the near field communication interface 21.

The authentication processor 24a implements a process of transmitting the user ID 23a to the authentication apparatus 4 in accordance with a request from the authentication apparatus 4. The user ID 23a transmitted to the authentication apparatus 4 is further transmitted to the authentication processor 34a of the vehicle-mounted apparatus 3 by the authentication apparatus 4.

The application executing part 24b is a processor that implements various processes relating to the group talk in accordance with the group talk application software 23b. Concretely, the application executing part 24b includes the image generator 241, the signal reception processor 242, and the signal transmission processor 243.

The image generator 241 is a processor that generates various images relating to the group talk and that transmits the generated images to the vehicle-mounted apparatus 3 via the near field communication interface 21. The images transmitted from the mobile terminal apparatus 2 to the vehicle-mounted apparatus 3 in such a manner are displayed on the touch screen display 32 of the vehicle-mounted apparatus 3.

The image generator 241 generates a group selection image used for selecting, for example, a group for which the group talk is implemented (hereinafter referred to as “objective group”). The group selection image includes a selection candidate image indicating one or more candidate groups that are selection candidates for the objective group. In addition, the group selection image includes a location image indicating current locations of the individual members belonging to one of the one or more candidate groups. Details of the group selection image are described later. The term “one or more candidate groups” means one of “one candidate group” and “a plurality of candidate groups,” in the following description.

Moreover, the signal reception processor 242 and the signal transmission processor 243 implement the group talk that is the voice communication among the members belonging to the same group, via the server 1. The signal reception processor 242 receives various types of information transmitted from the server 1. For example, the signal reception processor 242 receives the positioning information of individual members belonging to the predetermined group from the server 1, and transmits the received positioning information to the image generator 241.

Furthermore, when receiving the talk data, described later, from the server 1, the signal reception processor 242 implements a process of storing the received talk data to the memory 23. The talk data stored in the memory 23 is retrieved from the memory 23 in accordance with an input operation by the user to the touch screen display 32 of the vehicle-mounted apparatus 3, and then the voice data included in the talk data is output from the speaker 6.

The signal transmission processor 243 implements a process of transmitting the various types of information received from the vehicle-mounted apparatus 3 via the near field communication interface 21, to the server 1. For example, when receiving the voice data from the vehicle-mounted apparatus 3, the signal transmission processor 243 acquires the current positioning information from the positioning information acquisition part 22 and transmits the talk data including the voice data, the positioning information, time, the user ID, the group ID (described later), etc. to the server 1.

When receiving a boot instruction for the group talk application software 23b from the authentication processor 34a of the vehicle-mounted apparatus 3, the application executing part 24b implements a process of booting the group talk application software 23b in accordance with the boot instruction.

The memory 23 may store any software other than the group talk application software 23b. In such a case, the application executing part 24b also implements a process of executing the software, stored in the memory 23, other than the group talk application software 23b.

The navigation part 24c is a processor that provides route guidance to a destination, to the user, by using the positioning information acquired by the positioning information acquisition part 22 and the map information 23c stored in the memory 23. Route guidance information, showing a route to the destination, generated by the navigation part 24c is transmitted to the application executing part 24b.

Next, the configuration of the vehicle-mounted apparatus 3 is explained. The near field communication interface 31 is a communication device for Near Field Communication with the mobile terminal apparatus 2. The touch screen display 32 is an input and output device having a touch screen used for an input on the display on which various images are displayed. When receiving an input operation performed by the user, the touch screen display 32 transmits the operation information in accordance with the received input operation, to the operation information transmitter 34b.

The memory 33 is a storage device such as a nonvolatile memory or a hard disc drive, and stores the set information 33a. The set information 33a includes information where a registered user ID is associated with, for example, a user name, etc. of each user having the user ID.

Moreover, the set information 33a includes a “keyword.” The keyword is a special word for voice control for equipment in the vehicle 70, such as an air conditioner in the vehicle 70, or the navigation part 24c, etc. of the mobile terminal apparatus 2. The keyword is registered, for example, by the user in advance.

The controller 34 controls the whole vehicle-mounted apparatus 3 and includes the authentication processor 34a, the operation information transmitter 34b, the display controller 34c, the voice output controller 34d, the voice recognition processor 34e, and the execution instruction part 34f.

The authentication processor 34a performs user authentication based on the user ID received from the authentication apparatus 4. Concretely, the authentication processor 34a determines whether or not the user ID received from the authentication apparatus 4 is identical to the user ID included in the set information 33a. When determining that both ID are identical, the authentication processor 34a authenticates the user.

Moreover, when authenticating the user, the authentication processor 34a transmits the boot instruction for the group talk application software 23b via the near field communication interface 31 to the application executing part 24b of the mobile terminal apparatus 2. Thus, the application executing part 24b of the mobile terminal apparatus 2 boots the group talk application software 23b.

The operation information transmitter 34b is a processor that transmits the operation information received from the touch screen display 32 to the application executing part 24b of the mobile terminal apparatus 2 via the near field communication interface 31.

The display controller 34c is a processor that displays various images on the touch screen display 32. For example, the display controller 34c receives the group selection image from the mobile terminal apparatus 2 via the near field communication interface 31, and implements a process of displaying the received group selection image on the touch screen display 32.

The voice output controller 34d receives the talk data from the mobile terminal apparatus 2 via the near field communication interface 31 and implements a process of outputting voice from the speaker 6 based on the voice data included in the received talk data.

The voice recognition processor 34e transmits the voice data acquired by the microphone 5 to the mobile terminal apparatus 2 via the near field communication interface 31. Moreover, the voice recognition processor 34e implements a voice recognition process of recognizing talk contents from the voice data acquired by the microphone 5.

Furthermore, the voice recognition processor 34e compares the talk contents recognized via the voice recognition process with the keyword included in the set information 33a. When determining that the keyword is included in the talk contents, the voice recognition processor 34e also implements a process of transmitting the keyword to the execution instruction part 34f.

The execution instruction part 34f is a processor that, when receiving the keyword from the voice recognition processor 34e, implements a process of causing equipment, such as the air conditioner, to implement a process corresponding to the keyword. Moreover, when a process corresponding to the keyword is a process relating to navigation, the execution instruction part 34f transmits control data for implementing the process corresponding to the keyword, to the mobile terminal apparatus 2 via the near field communication interface 31.

When receiving synchronization control data, later described, from the mobile terminal apparatus 2 via the near field communication interface 31, the execution instruction part 34f causes applicable equipment to implement a process corresponding to control data included in the received synchronization control data. This matter is described later.

Only components and functions necessary to explain the characteristics of the mobile terminal apparatus 2 and the vehicle-mounted apparatus 3 have been described above. However, the mobile terminal apparatus 2 and the vehicle-mounted apparatus 3 may include a component or a function other than the components and the functions described above. For example, the voice output controller 34d of the vehicle-mounted apparatus 3 controls not only the operation described above but also an output of music, voice guidance, etc.

<1-3. Database>

Next described are contents of the user management information and the group management information managed respectively in the user management database 11a and the group management database 11b included in the server 1, with reference to FIG. 4A and FIG. 4B. FIG. 4A is a diagram showing an example of the user management information, and FIG. 4B is a diagram showing an example of the group management information.

As shown in FIG. 4, in the user management information, a “user name” item, an “icon image” item, a “current location” item, a “route” item, a “status” item, and a “belonging group” item are associated with each user ID.

Here the “user name” item stores a full name of a user. However, a user name may not be a real full name but may be a nickname of the user. The “icon image” item stores an image arbitrarily selected by the user as an icon image to identify the user, such as a picture of the user.

The “current location” item stores positioning information of the user. Concretely, the server 1 periodically collects the positioning information from the mobile terminal apparatus 2 of each of plural users, and updates the “current location” item in the user management information. As mentioned above, the server 1 manages the locations of the users by periodically collecting the positioning information from the plural mobile terminal apparatuses 2 of the users. The database included in the server 1 is an example of storing means that stores the positioning information acquired from the plural mobile terminal apparatuses 2.

The “route” item stores information relating to a route of the user such as an expected route to the destination, a followed route from a departure place to the current location, etc. For example, the server 1 acquires the route guidance information generated by the navigation part 24c, from the mobile terminal apparatus 2, and updates the “route” item.

The “status” item stores status information of the user. An example of the status information of the user is information indicating whether or not the user is in the vehicle 70. For example, the “status” item in the user management information in FIG. 4A stores “in vehicle,” which represents that a user (Taro Yamada) having a user ID No. “U01” is in the vehicle 70.

Whether or not the user is in the vehicle 70 can be determined by information transmitted from the mobile terminal apparatus 2.

For example, when the group talk application software 23b is booted by an instruction from the vehicle-mounted apparatus 3, the mobile terminal apparatus 2 transmits, to the server 1, information indicating that the user is in the vehicle 70 with the user ID. Moreover, when the group talk application software 23b is booted by a user operation, the mobile terminal apparatus 2 transmits, to the server 1, information indicating that the user is not in the vehicle 70 with the user ID. Then, the server 1 updates the “status” item in the user management information based on the information transmitted from the mobile terminal apparatus 2.

Whether or not the user is in the vehicle 70 may be determined based on a connection status (communication status of Near Field Communication) between the vehicle-mounted apparatus 3 and the mobile terminal apparatus 2. In this case, when the group talk application software 23b is booted in a state where the vehicle-mounted apparatus 3 is connected to the mobile terminal apparatus 2, the information indicating that the user is in the vehicle 70 is transmitted to the server 1 with the user ID. When the group talk application software 23b is booted in a state where the vehicle-mounted apparatus 3 is not connected to the mobile terminal apparatus 2, the information indicating that the user is not in the vehicle 70 is transmitted to the server 1 with the user ID.

The “belonging group” item stores identification information of a group (group ID) to which the user belongs. For example, in the case shown in FIG. 4A, belonging groups “G01,” “G02,” and “G03” are associated with the user ID “U01,” which represents that the user “Taro Yamada” is a member belonging to the three groups identified by the group IDs “G01,” “G02,” and “G03” respectively.

The user management information shown in FIG. 4A is only an example. The user management information may include an item other than the items shown in FIG. 4A.

Next, the contents of the group management information are explained with reference to FIG. 4B. As shown in FIG. 4B, in the group management information, a “group name” item, a “during talk” item, a “registered member” item, and a “communication history” item are associated with each group ID.

Here, the “group name” item stores a group name corresponding to the group ID. The “during talk” item stores information indicating whether or not a group corresponding to the group ID is currently conducting the group talk. For example, as shown in FIG. 4B, “true” is stored in the “during talk” item, which represents that the group ID “G01” is currently conducting the group talk.

The “registered member” item stores user IDs of users who are members belonging to the group corresponding to the group ID. Moreover, the “communication history” item is associated with each of the user IDs of the members stored in the “registered member” item and stores communication history of each member corresponding to each of the user IDs.

The “communication history” item includes a participation start time when each member starts participation in the group talk and a participation end time when the member ends the participation in the group talk, and information indicating whether or not the member is during the group talk.

As mentioned above, the server 1 includes the group management database 11b as a storing means that stores the group management information in which groups capable of the group talk are listed. Moreover, the server 1 includes the user management database 11a as a storing means that stores the user management information including the positioning information acquired from the mobile terminal apparatuses 2 owned by the members belonging to each group.

<1-4. Start Procedure of Group Talk>

Next explained is a procedure from a point where the user performs the user authentication by using the authentication apparatus 4 to a point where the group talk is started, with reference to exemplar screens displayed on the touch screen display 32 of the vehicle-mounted apparatus 3. Figs. from 5A to 5H are diagrams showing examples that will be displayed on the touch screen display 32.

When getting in the vehicle 70, the user who is a subscriber of the group talk service holds the mobile terminal apparatus 2 over the authentication apparatus 4. Thus, the user ID 23a stored in the memory 23 of the mobile terminal apparatus 2 is read out, and then the authentication processor 34a of the vehicle-mounted apparatus 3 performs the user authentication by using the user ID 23a and the set information 33a.

Next, when having authenticated the user, the authentication processor 34a transmits information indicating that the user has been authenticated, with the icon image, the user name, etc. of the user. Then, the display controller 34c generates an authentication success image based on the information, the icon image, the user name, etc. and displays the generated authentication success image on the touch screen display 32.

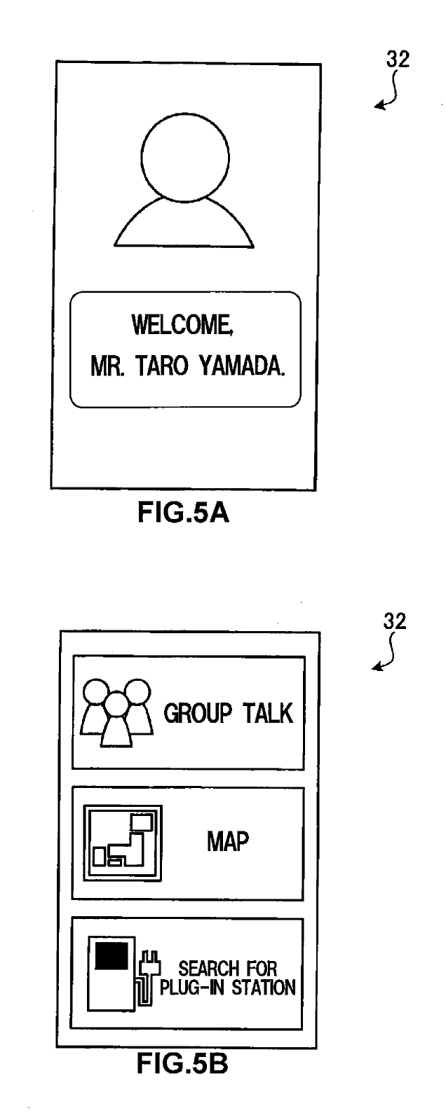

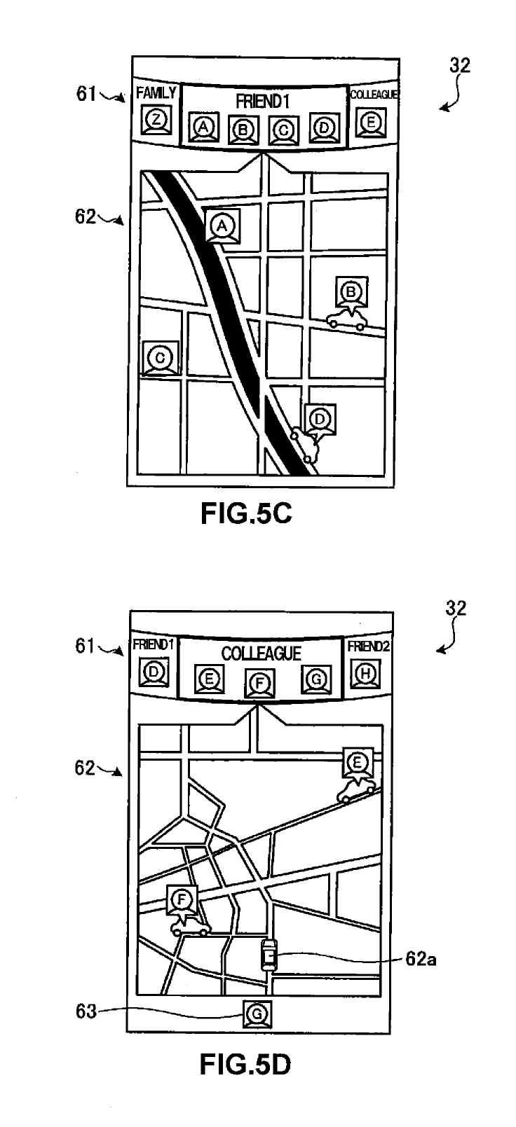

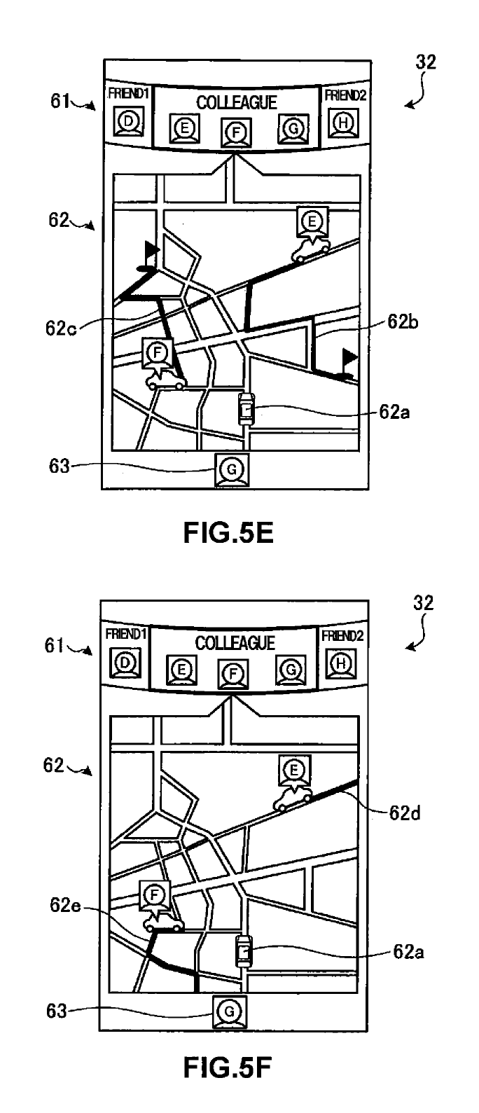

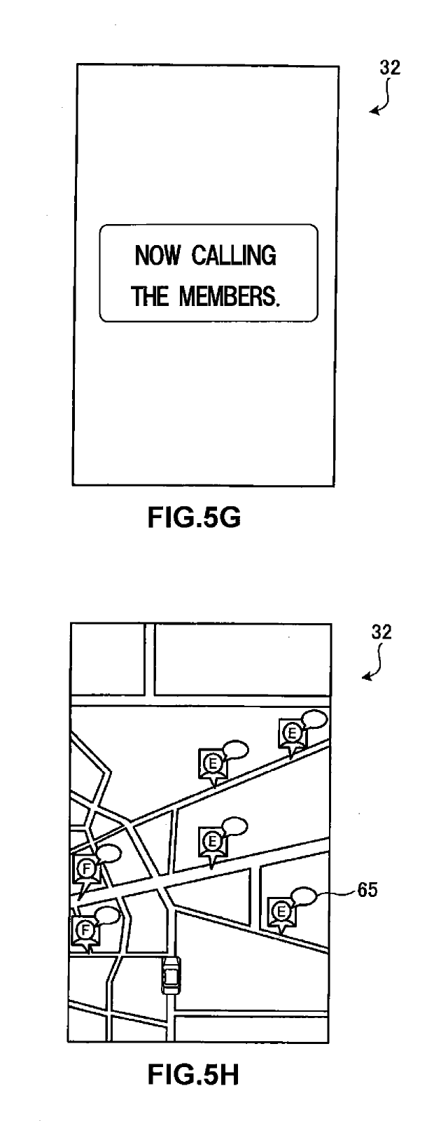

FIG. 5A shows an example of the authentication success image. As shown in FIG. 5A, the authentication success image includes the icon image, the user name, etc. of the authenticated user.

Moreover, when having authenticated the user, the authentication processor 34a transmits the boot instruction for booting the group talk application software 23b, to the application executing part 24b of the mobile terminal apparatus 2. The application executing part 24b boots the group talk application software 23b in accordance with the boot instruction. In this embodiment, the group talk application software 23b is automatically booted after the user has been authenticated. However, the group talk application software 23b may be booted when the user performs a predetermined operation after the user has been authenticated.

Next, in the mobile terminal apparatus 2, the image generator 241 of the application executing part 24b generates a menu screen and transmits the generated menu screen to the display controller 34c of the vehicle-mounted apparatus 3. Thus, the display controller 34c displays the menu screen received from the image generator 241 on the touch screen display 32 of the vehicle-mounted apparatus 3.

FIG. 5B is an example of the menu screen. As shown in FIG. 5B, the menu screen includes images (command buttons) corresponding to each of various services including the group talk service.

Here, for example, the user touches a command button corresponding to the group talk. In this case, in the vehicle-mounted apparatus 3, the operation information transmitter 34b receives the operation information from the touch screen display 32, and transmits the received operation information to the mobile terminal apparatus 2.

In the mobile terminal apparatus 2, when receiving, from the vehicle-mounted apparatus 3, the operation information indicating that the command button corresponding to the group talk service has been touched, the signal transmission processor 243 transmits an acquisition request for acquiring information necessary to generate the group selection image, along with the user ID 23a, the positioning information, etc., to the server 1.

When receiving such information, the server 1 refers to the user management information in the user management database 11a and retrieves the group ID of the group to which the user belongs. For example, if the user is Taro Yamada of the user ID “U01,” the server 1 retrieves the group IDs “G01,” “G02,” and “G03” in accordance with the user management information shown in FIG. 4A.

Then the server 1 retrieves, from the group management database 11b, the group management information corresponding to the retrieved group IDs. Moreover, the server 1 retrieves, from the user management database 11a, the user management information corresponding to the user ID of the “registered member” included in the retrieved group management information. For example, the server 1 retrieves the group management information corresponding to the group ID “G01” from the group management database 11b. Substantially simultaneously, the server 1 retrieves the user management information of a user “U02” who belongs to the group ID “G01,” from the user management database 11a.

The server 1 transmits the information retrieved from the user management database 11a and the group management database 11b, to the mobile terminal apparatus 2 which is a transmitter of the acquisition request. As described above, the controller of the server 1 functions as an example of a transmitting means that transmits the positioning information of the mobile terminal apparatus 2 stored in the database to each of the plural mobile terminal apparatuses 2 of the members belonging to a same group.

Next, in the mobile terminal apparatus 2, the signal reception processor 242 receives the information necessary to generate the group selection image from the server 1 and transmits the received information to the image generator 241. Then the image generator 241 generates the group selection image based on the information received from the signal reception processor 242 and the map information 23c stored in the memory 23. The group selection image is an image for selecting the objective group of the group talk.

When having generated the group selection image, the image generator 241 transmits the generated group selection image to the vehicle-mounted apparatus 3. In the vehicle-mounted apparatus 3, the display controller 34c displays the group selection image received from the image generator 241 on the touch screen display 32. In such a manner, the group selection image is displayed on the touch screen display 32 that is a touch-operable displaying means of the vehicle-mounted apparatus 3.

Moreover, the image generator 241 temporarily stores the information received from the signal reception processor 242, in the memory 23.

FIG. 5C illustrates an example of the group selection image. As shown in FIG. 5C, the group selection image includes a selection candidate image 61 and a location image 62.

The selection candidate image 61 is an image indicating the one or more candidate groups as selection candidates for the objective group for which the group talk will be started. In other words, the selection candidate image 61 is a list of the one or more candidate groups. Concretely, the selection candidate image 61 includes an image corresponding to each candidate group.

The selection candidate image 61 indicates a part of all the candidate groups. Concretely, a displaying method, so-called drum roll, in which images of the candidate groups are virtually rotated and changed in accordance with a user operation, is adopted for the selection candidate image 61.

Each of the images of the candidate groups includes, for example, a group name corresponding to one of the candidate groups and icon images representing the members belonging to the one candidate group. In a case shown in FIG. 5C, the selection candidate image 61 includes an image corresponding to a group name “Family,” an image corresponding to a group name “Friend 1,” and an image corresponding to a group name “Colleague,” of the candidate groups.

Moreover, the image of the candidate group “Friend 1” includes icon images of the four members (here, members A to D) belonging to the candidate group “Friend 1.” In addition, on left and right sides of the image of the candidate group “Friend1,” an image of the candidate group “Family” and an image of the candidate group “Colleague” are provided respectively. The image of the candidate group “Family” includes an icon image of a member Z, who is a part of the members belonging to the candidate group “Family.” The image of the candidate group “Colleague” includes an icon image of a member E, who is a part of the members belonging to the candidate group “Colleague.”

The group name is included in the group management information, and the icon images of the members belonging to the group are included in the user management information. The image generator 241 receives these information from the signal reception processor 242 and generates the selection candidate image 61.

In a center area of the selection candidate image 61 is a particular area in which a cursor for temporarily selecting a candidate group is located. Therefore, a candidate group in the center area of the selection candidate image 61 (“Friend 1” in FIG. 5C) is focused. The focused candidate group is the temporarily selected candidate group.

In addition, the location image 62 includes icon images indicating locations of the members belonging to the candidate group in the center area of the selection candidate image 61 (“Friend 1” in FIG. 5C). In other words, the location image 62 is a map image on which the icon images indicating the locations of the members belonging to the temporarily selected candidate group are located in accordance with the positioning information of the members.

For example, in the case shown in FIG. 5C, the candidate group “Friend 1” is located in the center area of the selection candidate image 61. On the location image 62, the icon images of the members A to D belonging to the candidate group “Friend 1” are superimposed on the map image.

At this time, the candidate group in the center area of the selection candidate image 61 is temporarily selected. Therefore, the location image 62 including the icon images of the members belonging to the temporarily selected candidate group is displayed on the touch screen display 32. In this state, the candidate group is determinably selected as the objective group by a user operation for determination, such as a touch operation or a press operation performed to the temporarily selected candidate group. In other words, in response to the user operation with the touch screen display 32, the temporarily selected candidate group is selected as the objective group of the group talk. As mentioned above, the touch screen display 32 functions as an example of a receiving means that receives the user operation for selecting the objective group from amongst the one or more candidate groups.

When the objective group has been selected, the signal transmission processor 243 instructs the server 1 to start the group talk for the selected objective group. Then, the signal reception processor 242 and the signal transmission processor 243 start the group talk for the objected group, via the server 1.

Even if the user performs the touch operation or the press operation to a candidate group that is not temporarily selected, the candidate group is not selected as the objective group. The candidate group that is not temporarily selected is not located in the center area of the selection candidate image 61. For example, the candidate groups that are not temporarily selected in FIG. 5C are the candidate groups “Family” and “Colleague” located on the left and right sides of the candidate group “Friend 1.” When the touch operation or the press operation is performed to a candidate group that is not temporarily selected, the candidate group to which the operation has been performed is moved to the center area of the selection candidate image 61 and is temporarily selected. As mentioned above, the touch screen display 32 functions as an example of a selecting means that temporarily selects one candidate group from amongst the one or more candidate groups.

Thus, the temporarily selected candidate group is selected in order for the user to check a status of the members belonging to the temporarily selected candidate group before participation in the group talk. The temporarily selected candidate group is specified by the cursor located in the center area of the selection candidate image 61.

As described above, the group communication system 100 in the first embodiment displays the location image 62 indicating the locations of the members belonging to the candidate group along with the selection candidate image 61, as the group selection image.

Concretely, the image generator 241 generates the group selection image used for selecting the objective group of the group communication. The group selection image includes the selection candidate image 61 indicating the one or more candidate groups as the selection candidates for the objective group, and the location image 62 on which the icon images representing the members belonging to the temporarily selected candidate group are located in accordance with the positioning information of the members.

Therefore, with an understanding of the locations of the members belonging to the candidate group, the user can determine whether or not to participate in the group talk of the candidate group. In other words, even without starting the group talk, the user can understand the locations of the members belonging to the candidate group. Thus, the user does not have to participate in the group talk at one point and end the participation immediately when the user desires to understand the locations of the members.

In the group communication system 100 in the first embodiment, the image generator 241 displays the selection candidate image 61 including a part of all the candidate groups on the touch screen display 32. Moreover, the image generator 241 changes the candidate group to be displayed in the selection candidate image 61, in accordance with the user operation with the touch screen display 32.

Concretely, when receiving operation information of the user operation performed to the selection candidate image 61 (for example, a left or a right slide operation) from the operation information transmitter 34b of the vehicle-mounted apparatus 3, the image generator 241 of the mobile terminal apparatus 2 generates a new selection candidate image 61 by sliding the images of the candidate groups in rotation, in accordance with the received operation information. Then the image generator 241 transmits the newly generated selection candidate image 61 to the display controller 34c of the vehicle-mounted apparatus 3. Thus, the images of the candidate groups slid in accordance with the slide operation by the user are displayed in the selection candidate image 61 on the touch screen display 32.

As mentioned above, in a case of the group communication system 100 in the first embodiment, the selection candidate image 61 can be compactly displayed in a display area on the touch screen display 32 by the drum roll displaying method and an area for displaying the location image 62 can be secured.

Moreover, in the case of the group communication system 100 in the first embodiment, as shown in FIG. 5C, the selection candidate image 61 and the location image 62 are vertically disposed. On the other hand, the images of the one or more candidate groups included in the selection candidate image 61 are laterally disposed. In such a manner, a larger area for displaying the location image 62 can be secured by disposing the images of the one or more candidate groups in a direction intersecting a direction in which the selection candidate image 61 and the location image 62 are disposed.

Furthermore, in the case of the group communication system 100 in the first embodiment, the touch screen display 32 displays the location image 62 relating to the candidate group in the particular area (the center area in this case) among the one or more candidate groups displayed in the selection candidate image 61. Therefore, the user can check the locations of the members belonging to an intended candidate group by positioning the intended candidate group (for example, the candidate group “Friend 1”) in the particular area.

The image generator 241 functions as an example of an example of a display controlling means that displays the list of the one or more candidate groups that are selection candidates for the objective group, on the displaying means of the vehicle-mounted apparatus 3. In addition, the image generator 241 functions also as a display controlling means that displays the map image including the icon images indicating the locations of the members belonging to the candidate group temporarily selected by the user, on the displaying means of the vehicle-mounted apparatus 3.

An example in which the drum roll method is adopted as the displaying method of displaying the selection candidate image 61 has been described here. However, the displaying method for the selection candidate image 61 is not limited to the drum roll method. Moreover, the one or more candidate groups shown in the selection candidate image 61 may be disposed in a same direction as the direction in which the selection candidate image 61 and the location image 62 are disposed. Furthermore, an example in which the location image 62 is disposed below the selection candidate image 61 has been described here. Contrarily, the selection candidate image 61 may be disposed below the location image 62.

In a case where there are many members belonging to the temporarily selected candidate group, only a part of the icon images of the members may be displayed as the images of the candidate group in the selection candidate image 61. In such a case, the members belonging to the candidate group may be displayed in a descending order of possibilities where the members belonging to the candidate group participate in the group talk. For example, the higher a rate of participation in the group talk, the higher a possibility of participation in the group talk. Moreover, it can be determined that any member who is disconnected (offline) currently has a low possibility of participation in the group talk. As described above, it is possible to select the objective group more appropriately by displaying the members belonging to the candidate group in the descending order of the possibility of participation in the group talk, on the touch screen display 32.

Moreover, the members belonging to the candidate group may be displayed in a chronological order of participation start time of the members, or may be displayed in a descending order of frequency of talk in the group talk. For example, members who have participated in the group talk earlier or who have talked more frequently may be determined more likely to be key members in the group talk. As mentioned above, it is possible to select the objective group more appropriately by displaying the members belonging to the candidate group in the descending order of the possibility of the key members in the group talk, on the touch screen display 32.

Furthermore, the image generator 241 changes a style of the icon images to be superimposed on the map image, in accordance with the status information of the members belonging to the candidate group among the information received from the signal reception processor 242.

For example, if the “status” item included in the user management information of a member A shows “not in vehicle,” the image generator 241 superimposes the icon image of the member A on the map image without change. On the other hand, if the “status” item included in the user management information of a member B shows “in vehicle,” the image generator 241 superimposes an image generated by combining the icon image of the member B with a vehicle illustration, on the map image.

As mentioned above, the user can understand the status of each member belonging to the candidate group by changing the image to be superimposed on the map image in accordance with the status of each member.

Moreover, the image generator 241 determines a scale of the map image included in the location image 62 based on the positioning information of the members belonging to the temporarily selected candidate group. In other words, the image generator 241 determines the scale of the map image such that the icon images of all the members belonging to the candidate group are included in the location image 62. Thus, the user can easily understand the locations of all the members belonging to the candidate group.

It has been explained above that the scale of the map image is changed based on the positioning information of the members. However, the scale of the map image may be fixed and not be changed. FIG. 5D illustrates an example of the group selection image on a fixed scale.

FIG. 5D illustrates an example where the candidate group “Colleague” is displayed in the center area and where the location image 62 indicating the locations of the member E, a member F and a member G is displayed as a result of a user operation to slide the selection candidate image 61 in FIG. 5C in a left direction.

As shown in FIG. 5D, when the scale of the map image is fixed, the image generator 241 generates the location image 62 superimposed with an icon image 62a generated based on the positioning information and the status information of the own apparatus and with the icon images generated based on the user management information (the positioning information, the status information, etc.) of the other members, on the map image having the fixed scale and having a base point that is the positioning information of the own apparatus, for example.

If a particular member, among the members belonging to the candidate group, is not located within a range of the map image, the image generator 241 generates, in addition to the location image 62, the group selection image further including an icon image 63 representing the particular member.

For example, among the members E to G belonging to the candidate group “Colleague,” when the member G is not located within the range of the map image, the image generator 241 generates the group selection image including the selection candidate image 61, the location image 62 and the icon image 63 of the member G Thus the icon image 63 of the member G not located in the range of the map image is displayed outside the display area of the location image 62, on the touch screen display 32.

Moreover, the icon image 63 of the member G displayed outside the display area of the location image 62 is disposed, corresponding to the direction in which the member G is located, outside the display area of the location image 62. Thus, the user can start the group talk with an understanding of positional relationship with the members belonging to the candidate group. For example, in a case shown in FIG. 5D, the member G is located posterior to the user.

As described above, in a case where the location image 62 is the map image of which scale is predetermined and on which the icon images of the members are superimposed, the touch screen display 32 further displays the icon image of the particular member located outside the display range of the map image. Therefore, the user can understand easily the particular member, among the members belonging to the candidate group, who is not located in a vicinity of the user himself/herself.

Moreover, the aforementioned paragraphs have described an example where the image generator 241 superimposes the icon images of the members on the map image. However, the image generator 241 may superimpose, in addition, an expected route to a destination of each member, on the map image. FIG. 5E illustrates an example of the group selection image including the location image 62 on which expected routes of the members are further superimposed.

As shown in FIG. 5E, the location image 62 includes an expected route 62b of the member E and an expected route 62c of the member F. Concretely, the image generator 241 superimposes the expected route 62b, using route information included in the user management information of the member E, and the expected route 62c, using route information included in the user management information of the member F, on the map image.

As described above, the user can select the objective group for which the group talk will be started, taking into consideration the destinations to which the members are heading because the location image 62 includes the expected routes 62b and 62c.

The image generator 241 may superimpose the followed route of each member from the departure place to the current location on the map image. For example, as shown in FIG. 5F, the image generator 241 superimposes followed routes 62d and 62e on the map image by using the route information respectively included in the user management information of the member E and the member F.

As described above, the user can select the objective group for which the group talk will be started, taking into consideration directions from which the members have come because the location image 62 includes the followed routes.

Furthermore, the scale of the image map may have a limitation so as not to display a too wide area. In this case, the image generator 241 disposes an icon image of a member not located within a range of the map image, on an end portion of the display area corresponding to a direction in which the member is located. In addition, in such a case, it is preferable to change a style of the icon image of the member by processing, such as color change processing or mark adding processing, to the icon image of the member. Such a change of the style allows the user to easily understand that the member is located outside the displayed map image.

With reference back to FIG. 5D, a case where the user has performed a touch operation to the image of the candidate group “Colleague” included in the selection candidate image 61 shown in FIG. 5C, is explained.

When the user touches the image of the candidate group “Colleague” included in the selection candidate image 61 shown in FIG. 5C, the candidate group “Colleague” is displayed in the center area of the selection candidate image 61. In other words, the cursor is located on the candidate group “Colleague,” and the candidate group “Colleague” is focused. Thus, the temporarily selected candidate group is changed from “Friend 1” to “Colleague.” As a result, an image indicating the locations of the members belonging to the candidate group “Colleague” is displayed as the location image 62, on the touch screen display 32.

After the candidate group “Colleague” is displayed in the center area of the selection candidate image 61 (in other words, after the candidate group “Colleague” is temporarily selected), the image of the candidate group “Colleague” is touched by the user, the operation information transmitter 34b of the vehicle-mounted apparatus 3 transmits the operation information of the touch operation to the mobile terminal apparatus 2. In the mobile terminal apparatus 2, when receiving the operation information, the application executing part 24b selects the candidate group “Colleague” as the objective group for which the group talk will be started. Then, the signal transmission processor 243 transmits a group talk start request including the group ID of the objective group and the user ID of the own apparatus, etc. Thus, the signal transmission processor 243 instructs the server 1 to start the group talk.

When receiving the group talk start request from the mobile terminal apparatus 2, the server 1 retrieves the group ID from the group talk start request and identifies the objective group corresponding to the group ID. Then the server 1 retrieves the user IDs of individual members belonging to the objective group from the group management database 11b. Moreover, the server 1 transmits a notice of checking whether or not the members can participate in the group talk, to the individual mobile terminal apparatuses 2 of the members corresponding to the retrieved user IDs.

Then when receiving a response indicating an intention to participate from at least one member belonging to the objective group, the server 1 starts the group talk. A screen with a message indicating that the members are being called, is displayed on the touch screen display 32, as shown in FIG. 5G, during waiting for the response of whether or not the members can participate in the group talk.

As described above, when the user performs a particular operation to the candidate group not temporarily selected, the candidate group to which the particular operation has been performed is temporarily selected. Moreover, when the user performs another particular operation to the temporarily selected candidate group, the temporarily selected candidate group is selected as the objective group of the group talk.

The signal transmission processor 243 of the mobile terminal apparatus 2 functions as an example of an instruction means that instructs the server 1 to start the group talk of the selected objective group, when an operation for selecting the objective group has been performed.

Moreover, when the group talk of the selected objective group is started, the image generator 241 generates a during-talk image indicating a location where the member belonging to the objective group has talked (in other words, a location where the talk data relating to the group talk has been transmitted). The during-talk image is displayed on the touch screen display 32. FIG. 5H illustrates an example of the during-talk image displayed on the touch screen display 32 during the group talk. A process during the group talk is hereinafter explained with reference to FIG. 5H.

When the user talks during the group talk, the talk contents are collected by the microphone 5 in the vehicle 70 and the voice recognition processor 34e of the vehicle-mounted apparatus 3 transmits the voice data collected via the microphone 5, to the mobile terminal apparatus 2. Moreover, when receiving the voice data from the mobile terminal apparatus 2, the signal transmission processor 243 of the mobile terminal apparatus 2 acquires the positioning information from the positioning information acquisition part 22 and generates the talk data including the voice data, the positioning information, time, the user ID, the group ID, etc., and then transmits the generated talk data to the server 1.

Next, when receiving the talk data from the mobile terminal apparatus 2, the server 1 transmits the received talk data to the mobile terminal apparatuses 2 of other members belonging to the same group. As described above, the controller of the server 1 functions as an example of a data processing means that collects the talk data of the mobile terminal apparatus 2 of each member belonging to the objective group, in accordance with an instruction from the mobile terminal apparatus 2 and that transmits the collected talk data to the mobile terminal apparatuses 2 of the other members. Thus the controller of the server 1 allows the mobile terminal apparatuses 2 of the members belonging to the objective group to share the talk data. When receiving the talk data from the mobile terminal apparatuses 2 of the other members, via the server 1, the signal reception processor 242 of the mobile terminal apparatus 2 stores the received talk data to the memory 23.

Moreover, in the mobile terminal apparatus 2, when new talk data is stored in the memory 23, the image generator 241 retrieves the user ID and the positioning information included in the newly stored talk data. In addition, the image generator 241 generates an image (hereinafter referred to as “twittering mark”) by combining the icon image of the member corresponding to the retrieved user ID with a predetermined image (for example, a speech balloon image).

Furthermore, the image generator 241 generates the during-talk image by superimposing the generated twittering mark on a location of the map image in accordance with the positioning information retrieved from the talk data. The image generator 241 transmits the generated during-talk image to the vehicle-mounted apparatus 3. Furthermore, the display controller 34c of the vehicle-mounted apparatus 3 displays the during-talk image received from the mobile terminal apparatus 2, on the touch screen display 32.

Thus, as shown in FIG. 5H, the during-talk image generated by superimposing the twittering mark 65 on the map image is displayed on the touch screen display 32. The during-talk image indicates the location where the member belonging to the objective group has transmitted the talk data. The during-talk image is updated every time when the member belonging to the objective group transmits the talk data, and then a new twittering mark 65 will be added on the map image.

As described above, when a selection operation for selecting the objective group from amongst the one or more candidate groups has been performed, the display controller 34c displays the during-talk image, on the touch screen display 32, for the group talk to be started between the mobile terminal apparatuses 2 of the members belonging to the selected objective group and the mobile terminal apparatus 2 with which a host vehicle-mounted apparatus of the display controller 34c has established a communication link.

By touching the twittering mark 65 displayed on the touch screen display 32, the user can hear a voice message corresponding to the touched twittering mark 65.

Concretely, in the vehicle-mounted apparatus 3, the operation information transmitter 34b receives the operation information of the touch operation on the twittering mark 65 from the touch screen display 32, and transmits the received operation information to the mobile terminal apparatus 2. Moreover, in the mobile terminal apparatus 2, when receiving the above-mentioned operation information from the vehicle-mounted apparatus 3, the application executing part 24b retrieves the voice data from the talk data corresponding to the twittering mark 65 touched by the user, and then transmits the retrieved voice data to the vehicle-mounted apparatus 3.

Furthermore, in the vehicle-mounted apparatus 3, the voice output controller 34d outputs the voice message corresponding to the twittering mark 65 touched by the user, based on the voice data received by the mobile terminal apparatus 2.

Here, a case where the voice message is played back by touching the twittering mark 65, i.e. a case where the group talk is conducted via voice, has been explained. However, for example, the group talk may be conducted via text.

In such a case, the voice recognition processor 34e of the vehicle-mounted apparatus 3 may convert the voice data acquired via the microphone 5 to text data by the voice recognition process, and the signal transmission processor 243 of the mobile terminal apparatus 2 may transmit the talk data including the text data to the server 1. Thus, when the user touches the twittering mark 65, the display controller 34c displays, on the touch screen display 32a text message, corresponding to the touched twittering mark 65.

In addition, another example may be a configuration where the voice data is transmitted from the signal transmission processor 243 of the mobile terminal apparatus 2 to the server 1 and where the voice data is converted to the text data in the server 1.

An example where the objective group for which the group talk will be started is selected from amongst the plurality of registered candidate groups has been explained with reference to FIG. 5A to FIG. 5H. However, a method of starting the group talk is not limited to selecting an objective group, but the group talk may be started by forming a new group to start the group talk. Such a method of starting the group talk will be described later.

<1-5. Operation>

<1-5-1. Application Boot Process>

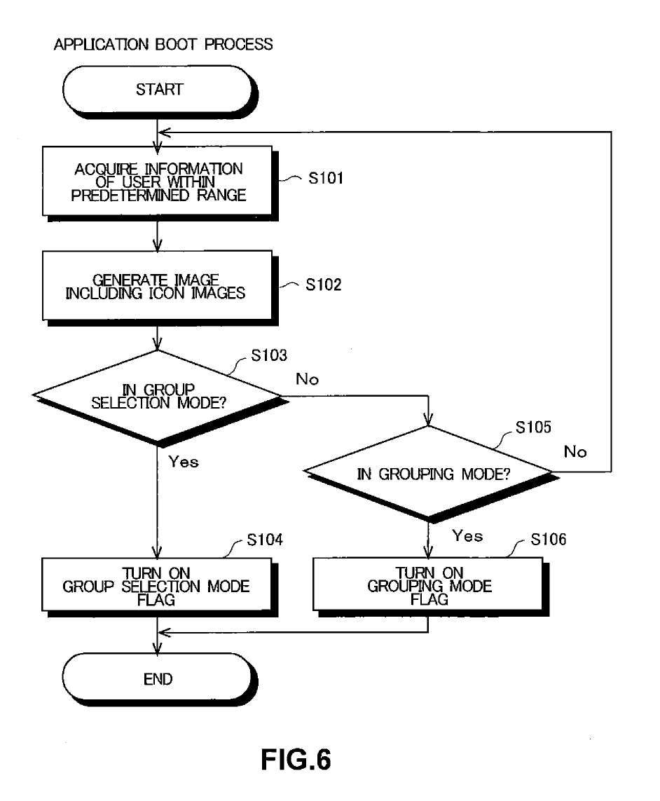

Next explained are concrete operations of the server 1, the mobile terminal apparatus 2 and the vehicle-mounted apparatus 3. First, an application boot process implemented by the mobile terminal apparatus 2 is explained with reference to FIG. 6. FIG. 6 is a flowchart showing a procedure of the application boot process.

The application boot process is a process from a time point when the mobile terminal apparatus 2 is instructed to boot the group talk application software 23b to a time point when a group selection mode flag or a grouping mode flag, described later, is turned on.

As shown in FIG. 6, in the mobile terminal apparatus 2, first, the signal reception processor 242 acquires, from the server 1, the user management information of users of the group talk service, who are located within a predetermined range from the own apparatus of the signal reception processor 242 (a step S101). Next, the image generator 241 generates an image including a map image on which the icon images of the users of the group talk service are superimposed, based on the user management information acquired by the signal reception processor 242 (a step S102).

Next, in the mobile terminal apparatus 2, the signal transmission processor 243 determines whether or not a “group selection mode” has been selected (a step S103). Here, the “group selection mode” is a mode for selecting an objective group for which the group talk will be started, from amongst the plurality of registered candidate groups.

For example, in addition to the image generated in the step S102, a command button for selecting the “group selection mode” and a command button for selecting a “grouping mode,” later described, are displayed on the touch screen display 32. Then when a user performs a touch operation to the command button for selecting the “group selection mode,” the operation information transmitter 34b of the vehicle-mounted apparatus 3 transmits the operation information to the mobile terminal apparatus 2. Thus the signal transmission processor 243 of the mobile terminal apparatus 2 determines that the “group selection mode” has been selected.

When it is determined in the step 103 that the “group selection mode” has been selected (Yes in the step S103), the application executing part 24b turns on the group selection flag mode (a step S104) and ends the application boot process.

Contrarily, when the “group selection mode” has not been selected (No in the step S103), the signal transmission processor 243 determines whether or not the “grouping mode” has been selected (a step S105). Then when it is determined that the “grouping mode” has been selected in the step 105 (Yes in the step S105), the application executing part 24b turns on the grouping mode flag (a step S106) and ends the application boot process.

When the “grouping mode” has not been selected in the step S105 (No in the step S105), the application executing part 24b moves the process back to the step S101, and repeats the process from the step S101.

<1-5-2. Group Selection Process>

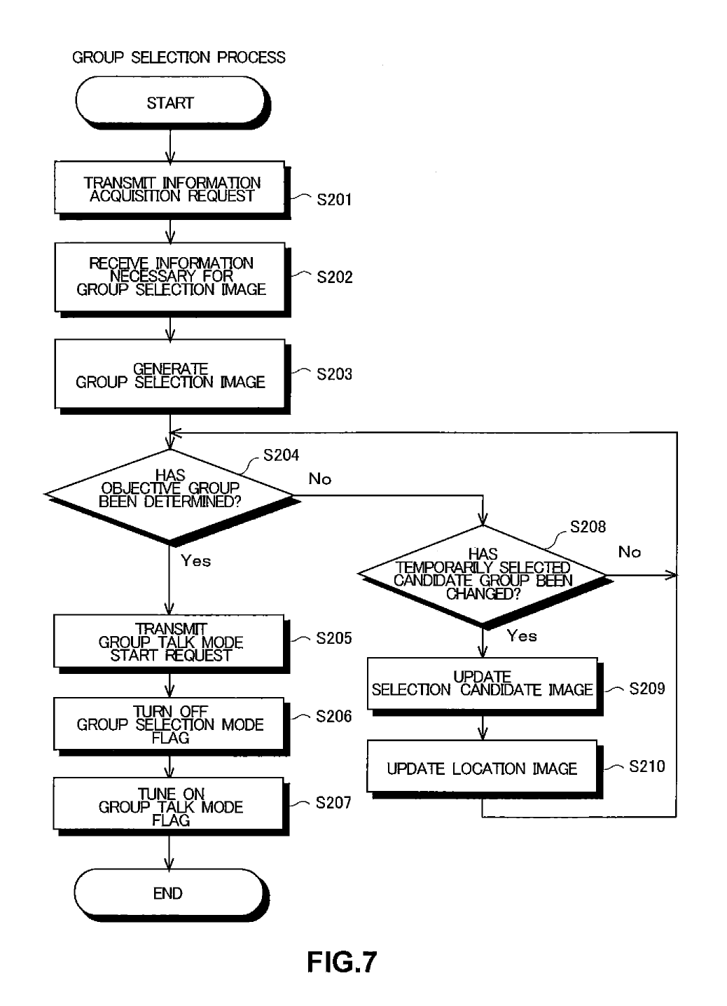

Next explained is a procedure of a group selection process implemented by the mobile terminal apparatus 2, with reference to FIG. 7. FIG. 7 is a flowchart showing the procedure of the group selection process. The group selection process is implemented when the group selection mode flag is turned on in the step S104 shown in FIG. 6.

As shown in FIG. 7, when the group selection process is started, the signal transmission processor 243 of the mobile terminal apparatus 2 transmits the information acquisition request to acquire information necessary to generate the group selection image, along with the user ID 23a, the positioning information, etc. to the server 1 (a step S201).

Next, in the mobile terminal apparatus 2, the signal reception processor 242 receives information necessary to generate the group selection image (a step S202), and the image generator 241 generates the group selection image including the selection candidate image 61 and the location image 62 (a step S203). Thus the group selection image is displayed by the display controller 34c on the touch screen display 32.

Next, the signal transmission processor 243 determines whether or not an operation for determining the objective group (a user operation for determinably selecting the objective group) has been performed (a step S204). For example, when receiving operation information indicating that a touch operation has been performed to the image of the candidate group shown in the center area of the selection candidate image 61, i.e. to the image of the temporarily selected candidate group, from the vehicle-mounted apparatus 3, the signal transmission processor 243 determines that the operation for determining the objective group has been performed.

When the signal transmission processor 243 determines that the operation for determining the objective group has been performed in the step S204 (Yes in the step S204), the application executing part 24b transmits a group talk mode start request to the server 1 (a step S205). Then the application executing part 24b turns off the group selection mode flag (a step S206) and substantially simultaneously tunes on a group talk mode flag (a step S207), and then ends the group selection process.

On the other hand, when the operation for determining the objective group has not been performed in the step S204 (No in the step S204), the signal transmission processor 243 determines whether or not an operation for changing the temporarily selected candidate group has been performed (a step S208). An example of the operation for changing the temporarily selected candidate group is a touch operation to a candidate group that has not been temporarily selected or a slide operation for sliding the selection candidate image 61. When receiving, from the vehicle-mounted apparatus 3, operation information indicating that such operation has been performed to the selection candidate image 61, the signal transmission processor 243 determines that the operation for changing the temporarily selected candidate group has been performed.

When the signal transmission processor 243 determines that the operation for changing the temporarily selected candidate group has been performed in the step S208 (Yes in the step S208), the image generator 241 updates the selection candidate image 61 (a step S209), and substantially simultaneously updates the location image 62 (a step S210), and then returns the step to the step S204. When the operation for changing the temporarily selected candidate group has not been performed (No in the step 208), the application executing part 24b also returns the process to the step S204.

<1-5-3. Group Talk Transmission Process>

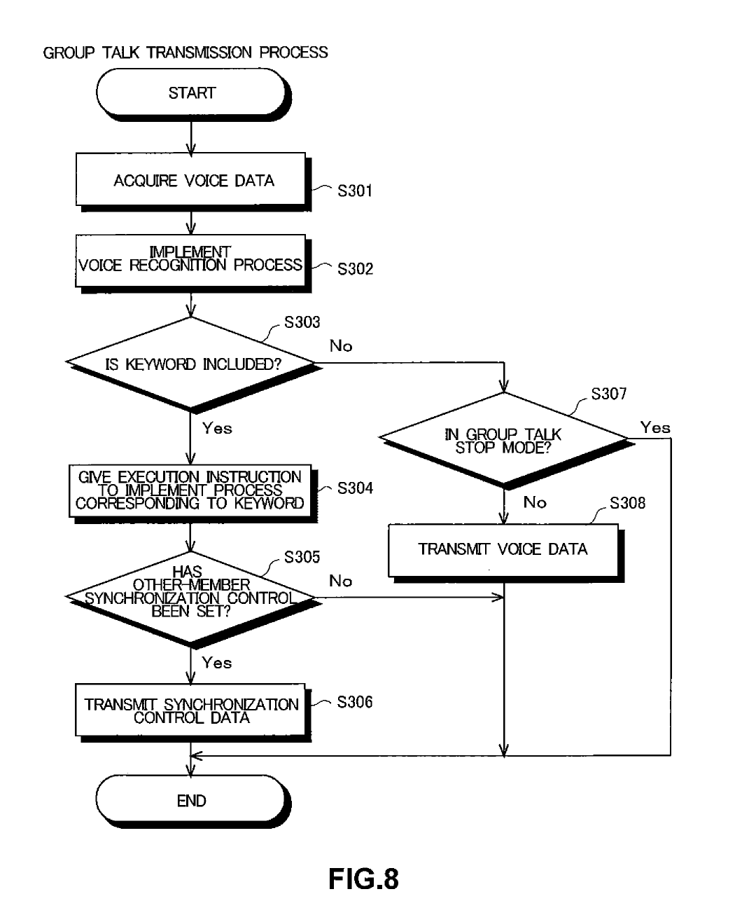

Next explained is a procedure of a group talk transmission process implemented by the vehicle-mounted apparatus 3, with reference to FIG. 8. FIG. 8 is a flowchart showing a procedure of the group talk transmission process. Here, the group talk transmission process is a process relating to transmission of talk data, etc. among the processes to be implemented when the group talk mode flag is tuned on. The group talk transmission process shown in FIG. 8 is implemented repeatedly while the group talk flag is on.

As shown in FIG. 8, when the group talk transmission process is started, the voice recognition processor 34e of the vehicle-mounted apparatus 3 acquires the voice data via the microphone 5 (a step S301), and implements the voice recognition process using the acquired voice data (a step S302).

Next, the voice recognition processor 34e determines whether or not the keyword is included in the talk contents (a step S303). The keyword is, as mentioned above, the special word for controlling the air conditioner, etc. in the vehicle 70 or the navigation part 24c, etc. included in the mobile terminal apparatus 2 by voice.

When the voice recognition processor 34e determines that the keyword is included in the talk contents in the step S303 (Yes in the step S303), the execution instruction part 34f gives an execution instruction to implement a process corresponding to the keyword (a step S304).

Moreover, the execution instruction part 34f determines whether or not an other-member synchronization control has been set (a step S305). Here, the other-member synchronization control means a control that also causes the vehicle 70 and/or the mobile terminal apparatuses 2 of other users belonging to the same group to implement the process corresponding to the keyword.

It is preferable to configure the other-member synchronization control to be set for each keyword. For example, it is preferable to adopt a configuration in which implementation or non-implementation of a process for the mobile terminal apparatuses 2 of the other members can be changed for each keyword, such as a case where the other-member synchronization control is set for the keyword KW1 but not set for the keyword KW2.

When the other-member synchronization control has been set in the step S305 (Yes in the step S305), the execution instruction part 34f transmits synchronization control data including a control command of which contents are the same as the execution instruction in the step S304, to the mobile terminal apparatuses 2 (a step S306), and ends the group talk transmission process. As mentioned above, when the keyword registered beforehand is included, the execution instruction part 34f transmits the synchronization control data for implementing the process corresponding to the keyword, to the server via the mobile terminal apparatus 2.

Implementation or non-implementation of the other-member synchronization control is set for each keyword. For example, the other-member synchronization control is more likely to be set for a function for which a same action is suited to be implemented by members in a same group, such as destination setting, while the other-member synchronization control is more likely not to be set for a function for which control differs depending on vehicles, such as air conditioner control.

When the talk contents do not include the keyword in the step S303 (No in the step S303), the controller 34 determines whether or not the group talk is currently in a group talk stop mode (a step S307). For example, when a group talk stop button that is a command button included in the during-talk image has been touched, the controller 34 determines that the group talk is currently in the group talk stop mode.

When the group talk is not currently in the group talk stop mode in the step S307 (No in the step S307), the voice recognition processor 34e transmits the voice data acquired in the step S301 to the mobile terminal apparatuses 2 (a step S308). Then when the process in the step S308 is transmitted or when the other-member synchronization control has not been set in the step S305 (No in the step S305), the controller 34 ends the group talk transmission process. Moreover, the controller 34 ends the group talk transmission process when determining that the group talk is currently in the group talk stop mode (Yes in the step S307).

The voice data transmitted by the voice recognition processor 34e is received by the signal transmission processor 243 of the mobile terminal apparatus 2. Then the signal transmission processor 243 generates the talk data including the voice data, the positioning data, the time, the user ID, the group ID, etc. and transmits the generated talk data to the server 1.

<1-5-4. Group Talk Reception Process>

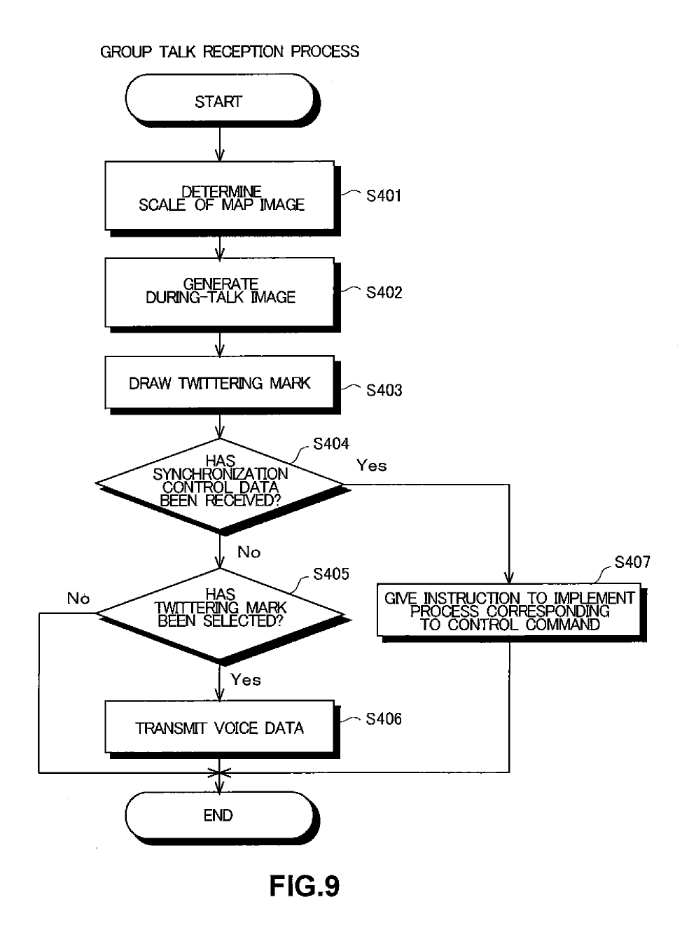

Next described is a procedure of a group talk reception process implemented by the mobile terminal apparatus 2, with reference to FIG. 9. Here, the group talk reception process is a process relating to reception of the talk data, etc., among the processes implemented when the group talk mode flag is turned on. The group talk reception process shown in FIG. 9 is implemented repeatedly while the group talk flag is on.

As shown in FIG. 9, when the group talk reception process is started, the image generator 241 of the mobile terminal apparatus 2 determines the scale of the map image in accordance with the positioning information of the members belonging to the objective group (a step S401). Then the image generator 241 generates the during-talk image by superimposing the icon images of the members on the map image of the determined scale (a step S402).

Thus, the during-talk image is displayed by the display controller 34c on the touch screen display 32. The icon image of each member is determined in accordance with a status of each member. For example, when the status information of the member is “in vehicle,” an image generated by combining the predetermined icon image of the member with a vehicle illustration is used as the icon image of the member.

Next, in the mobile terminal apparatus 2, the image generator 241 implements a drawing process of the twittering mark 65 (a step S403). In other words, the image generator 241 generates the during-talk image by adding the twittering mark 65 to the map image.

Then, the signal reception processor 242 determines whether or not the signal reception processor 242 has received the synchronization control data (a step S404). When it is determined that the signal reception processor 242 has not received the synchronization control data in the step S404 (No in the step S404), the signal transmission processor 243 determines whether or not a selection operation for selecting the twittering mark 65 has been performed (a step S405). For example, when having received, from the vehicle-mounted apparatus 3, operation information indicating that a touch operation with the twittering mark 65 has been performed, the signal transmission processor 243 determines that the selection operation for selecting the twittering mark 65 has been performed.

When the signal transmission processor 243 determines that the selection operation for selecting the twittering mark 65 has been performed in the step S405 (Yes in the step S405), the application executing part 24b retrieves the voice date corresponding to the selected twittering mark 65 from the memory 23 and transmits the retrieved voice data to the vehicle-mounted apparatus 3 (a step S406), and ends the process. The application executing part 24b ends the process also when the selection operation for selecting the twittering mark 65 has not been performed in the step S405 (No in the step S405).

Moreover, when it is determined that the signal reception processor 242 has received the synchronization control data in the step S404 (Yes in the step S404), the application executing part 24b gives an execution instruction to implement a process corresponding to the control command included in the synchronization control data (a step S407), and ends the group talk reception process.

When objective equipment to be controlled by the synchronization control data is equipment mounted in the vehicle 70, the application executing part 24b transmits the received synchronization control data to the vehicle-mounted apparatus 3. Thus, the execution instruction part 34f of the vehicle-mounted apparatus 3 gives an instruction to implement the process corresponding to the control command included in the synchronization control data. As described above, when receiving the synchronization control data from the server 1, the execution instruction part 34f causes the process corresponding to the received synchronization control data to be implemented. Moreover, the process corresponding to the control command included in the synchronization control data may be implemented after a user approval for the implementation.

<1-5-5. Terminal Side Participation End Process>

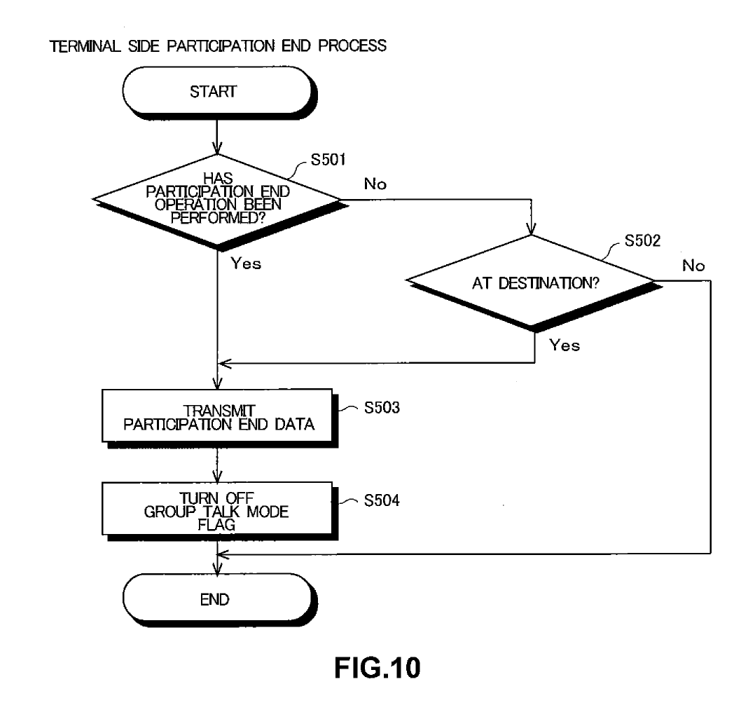

Next described is a procedure of a terminal side participation end process that is a participation end process implemented by the mobile terminal apparatus 2, with reference to FIG. 10. FIG. 10 is a flowchart showing the procedure of the terminal side participation end process. Here, the participation end process means a process of ending the group talk.

As shown in FIG. 10, when the terminal side participation end process is started, the signal transmission processor 243 of the mobile terminal apparatus 2 determines whether or not a participation end operation has been performed (in a step S501). For example, when having received, from the vehicle-mounted apparatus 3, operation information indicating that a participation end button, not illustrated, displayed on the touch screen display 32 has been touched, the signal transmission processor 243 of the mobile terminal apparatus 2 determines that the participation end operation has been performed.

When the participation end operation has not been performed in the step S501 (No in the step S501), the navigation part 24c determines whether or not the user has arrived at a set destination (a step S502). When the navigation part 24c determines that the user has not arrived at the set destination in the step S502 (No in the step S502), the application executing part 24b ends the terminal side participation end process.

On the other hand, when the participation end operation has been performed (Yes in the step S501), or when the navigation part 24c determines that the user has arrived at the set destination in the step S502 (Yes in the step S502), the signal transmission processor 243 transmits participation end data including the user ID 23a, the group ID, etc. to the server 1 (a step S503). Then the application executing part 24b turns off the group talk mode flag (a step S504), and ends the terminal side participation end process. Moreover, the application executing part 24b ends the terminal side participation end process also when the user has not arrived at the destination in the step S 502 (No in the step S502).

As described above, also when the user arrives at the destination, the participation end data is transmitted because the user usually starts actions for a next purpose after the user arrives at the destination. For example, after arriving at the destination in the vehicle, the user gets out of the vehicle and starts a different action depending on the destination. The user usually ends the group talk because situations in which the user is will be totally different from situations in the vehicle. Therefore, such an automatic participation end process that automatically transmits the participation end data, etc., on a condition that the user arrives at a destination, allows the user to end the participation without performing an operation necessary to end the participation. However, to make sure, when the user arrives at the destination, the participation end process may be implemented based on a participation end confirmation operation performed by the user (a user operation to a participation end confirmation button displayed on the touch screen display).

When the user arrives at the destination, a confirmation screen may be displayed on the touch screen display 32, to confirm whether or not the user ends the participation in the group talk, and if an operation for ending the participation is performed, the steps from the step S503 may be implemented. Moreover, in such a case, for user convenience, the process may move to the step S503 also when the operation has not been performed within a predetermined time period after the confirmation screen is displayed.

<1-5-6. Server Side Participation End Process>

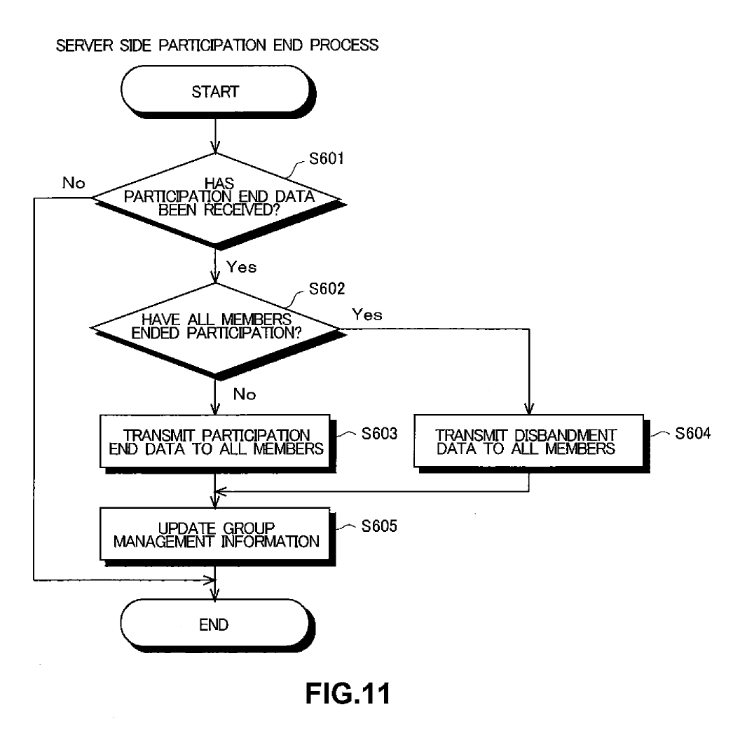

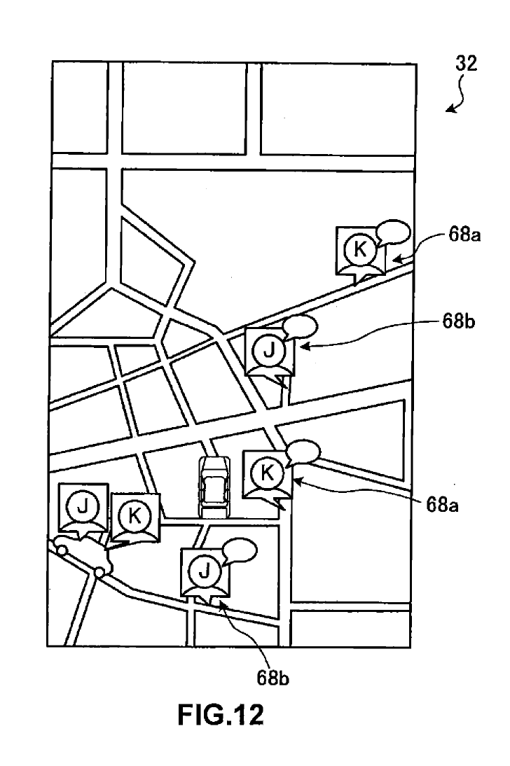

Next described is a procedure of a server side participation end process that is a participation end process implemented by the server 1, with reference to FIG. 11. FIG. 11 is a flowchart showing the procedure of the server side participation end process. The participation end process is implemented by detecting a reception of the participation end data from the user.

As shown in FIG. 11, the server 1 determines whether or not the server 1 has received the participation end data from the mobile terminal apparatus 2 (a step S601). When determining that the server 1 has received the participation end data (Yes in the step S601), the server 1 determines whether or not all members of a group, for which the server 1 has received the participation end data, of the group talk, have ended the participation in the group talk (a step S602). When the server 1 determines in the step S602 that the all members of the group have not ended the participation in the group talk (No in the step S602), i.e., when at least one member of the group still participates in the group talk, the server 1 transmits the received participation end data to the mobile terminal apparatuses 2 of the all members, including a member who has already ended the group talk, of the group (a step S603).

In the mobile terminal apparatus 2, when receiving the participation end data from the server 1, the image generator 241 generates a message indicating that the user who is a transmitter of the participation end data has ended the participation in the group talk, and transmits the generated message to the display controller 34c of the vehicle-mounted apparatus 3. The image generator 241 may, substantially simultaneously, remove the icon image of the user who is the transmitter of the participation end data, from the map image, or may change a style of the icon image of the user.

When determining in the step S602 that the all members have ended the participation in the group talk (Yes in the step S602), the server 1 transmits disbandment data to the mobile terminal apparatuses 2 of the all members including the member who has already ended the participation (a step S604). The disbandment data is data indicating an end of the group talk. When receiving the disbandment data from the server 1, in the mobile terminal apparatus 2, the image generator 241 generates a message indicating the end of the group talk (i.e. the disbandment of the group) and transmits the generated message to the display controller 34c of the vehicle-mounted apparatus 3.

When ending the step S603 or the step S604, the server 1 updates the group management information of the group of which group talk has been ended (a step S605), and ends the server side participation end process. When having not received the participation end data in the step S601 (No in the step S601), the server 1 also ends the server side participation end process.

As mentioned above, by the server 1 transmitting the participation end data or the disbandment data to the all members including the member who has already ended the participation, the all members can understand a member who has ended the participation and time when the member has ended participation, or time when the group has been disbanded, even after the member has ended the participation.

In this embodiment, the disbandment process is implemented when the server 1 determines that the all members have ended the participation in the group talk (Yes in the step S602), because there is a possibility of a case where a member who has ended the group talk re-participates after knowing continuation of the group talk. However, the disbandment process may be implemented when only one member is participating in the group talk because that is a situation where the group talk can not be formed.

As mentioned above, in the first embodiment, the image generator 241 of the mobile terminal apparatus 2 generates the group selection image used for selecting the objective group of the group talk. The group selection image includes the selection candidate image including the one or more candidate groups that are selection candidates for the objective group. The group selection image also includes the location image indicating, on the map image, the icon image of each member belonging to one candidate group at a location, corresponding to the positioning information of the member.

Moreover, in the first embodiment, the database of the server 1 functions as an example of a storing means that stores the positioning information retrieved from the plurality of mobile terminal apparatuses. The controller of the server 1 functions as an example of a signal transmitting means that transmits the positioning information stored in the database to the plurality of mobile terminal apparatuses. In addition, the controller of the server 1 functions as an example of a data processing means that collects communication data of the mobile terminal apparatus 2 of each member belonging to the objective group and that transmits the collected data to the mobile terminal apparatuses 2 of other members.

Furthermore, in the first embodiment, the controller 24 of the mobile terminal apparatus 2 functions respectively as an example of: a) a display controlling means that displays the list of the one or more candidate groups that are the selection candidates for the objective group of the group communication; b) a display controlling means that displays, on the displaying means, the map image including the icon images indicating the locations of the members belonging to one candidate group temporarily selected by the user from amongst the one or more candidate groups; and c) an instruction means that instructs the server to start the group talk for the selected objective group when the objective group has been selected from amongst the one or more candidate groups.

Therefore, according to the first embodiment, before participating in the group talk, a user can understand locations of members belonging to a group.

### 2. Second Embodiment

In the first embodiment mentioned above, a case where one user uses one mobile terminal apparatus has been explained. However, for example, if plural members belonging to a same group are in one vehicle, there may be a case where the plural members desire to conduct a group talk by sharing and using one mobile terminal apparatus owned by one of the plural members.

However, conventional technologies have a problem that even if one mobile terminal apparatus is shared by the plural members, the mobile terminal apparatus is recognized to be used by one member in the group talk service. In other words, even when one mobile terminal apparatus is shared by the plural members, only one member (an owner of the mobile terminal apparatus) is displayed on a display of a mobile terminal apparatus of another member. Therefore, fun of the group talk is reduced.

Moreover, the conventional technologies reduce the fun of the group talk because members other than the plural members in the vehicle cannot understand that the plural members are in the one vehicle.

Therefore, an example of a vehicle-mounted apparatus and a group communication system capable of enhancing the fun of group communication, is hereinafter explained. In the following explanation, the same reference numbers will be used for indicating portions same as or similar to the portions already described above in order to omit duplication of the explanation.

FIG. 12 is an exemplar during-talk image in a second embodiment. As shown in FIG. 12, an image generated by combining, for example, an icon image of a member J and an icon image of a member K with illustrations of cars is superimposed on a map image. The map image indicates that the members J and K are in a same vehicle 70.

As shown in FIG. 12, in the second embodiment, it can be easily understood that plural members are in one vehicle 70.

Moreover, as shown in FIG. 12, for example, a twittering mark 68a generated by combining the icon image of the member K and a speech balloon image and a twittering mark 68b generated by combining the icon image of the member J and a speech balloon image are superimposed on the map image.

As a result, even when one mobile terminal apparatus 2 is shared by the plural members, it can be easily understood to whom a voice message belongs even without actually hearing the voice message.

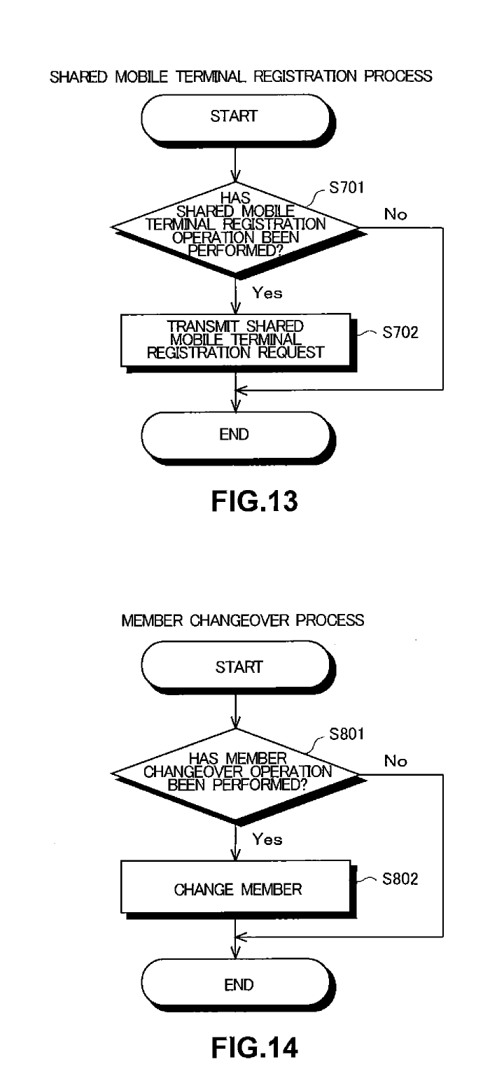

Next described is a concrete operation of the mobile terminal apparatus 2 in the second embodiment. First, a procedure for a shared mobile terminal registration process is explained with reference to FIG. 13. Here, the shared mobile terminal registration process means a registration process of sharing one mobile terminal apparatus 2 by the plural members (users). The process is repeated while the group communication system is working.

As shown in FIG. 13, when the shared mobile terminal registration process is started, a signal transmission processor 243 of the mobile terminal apparatus 2 determines whether or not a shared mobile terminal registration operation has been performed (a step S701). For example, when receiving information necessary to share the mobile terminal apparatus 2 (e.g., a user ID of a member who is in the same vehicle, etc.) from a vehicle-mounted apparatus 3, the signal transmission processor 243 determines that the shared mobile terminal registration operation has been performed.

When determining that the shared mobile terminal registration operation has been performed (Yes in the step S701), the signal transmission processor 243 transmits a shared mobile terminal registration request including the information received from the vehicle-mounted apparatus 3 and the own apparatus of the signal transmission processor 243 to a server 1 (a step S702), and ends the shared mobile terminal registration process.

When receiving the shared mobile terminal registration request from the mobile terminal apparatus 2, the server 1 registers the shared mobile terminal (e.g. registration on a user management database 11a and/or on a group management database 11b) based on the received shared mobile terminal registration request. An application executing part 24b also ends the shared mobile terminal registration process when the shared mobile terminal registration operation has not been performed (No in the step S701).

Here, the procedure of the shared mobile terminal registration process mentioned above is explained taking as an example a case where the mobile terminal apparatus 2 of the member K is shared with the member J. In this example, each of the member J and the member K possesses own mobile terminal apparatus 2 and also each of user management information of the member J and the member K is registered to the user management database 11a. Moreover, the mobile terminal apparatus 2 of the member K is in a state where a communication link has been established with the vehicle-mounted apparatus 3.

For example, the member J holds the mobile terminal apparatus 2 owned by the member J over an authentication apparatus 4 provided in the vehicle 70 in which the member J is located. Thus a user ID of the member J read out by the authentication apparatus 4 is transmitted to the vehicle-mounted apparatus 3. Moreover, a controller 34 of the vehicle-mounted apparatus 3 transmits the user ID of the member J received from the authentication apparatus 4, to the mobile terminal apparatus 2 of the member K.

Then in the mobile terminal apparatus 2 of the member K, the signal transmission processor 243 receives the user ID of the member J from the vehicle-mounted apparatus 3, and substantially simultaneously transmits the shared mobile terminal registration request including the received user ID and the user ID of the own apparatus, to the server 1.

When receiving the shared mobile terminal registration request from the mobile terminal apparatus 2 the server 1, for example, associates the user ID of the member J, as a user ID of a sharing member, with a user ID of the member K stored in a “registered member” item included in group management information of an objective group of a group talk in which the member K is participating.

Thus the mobile terminal apparatuses 2 of other members can understand that one mobile terminal apparatus 2 is shared by the members J and K. Moreover, the user management information of the member K includes status information indicating that the member K is in a vehicle. Therefore, the mobile terminal apparatuses 2 of the other members can also understand that the members K and J are in one vehicle 70.

If the user management information of the member J is not registered in the user management database 11a, the member J may input or select information (a user name, an icon image, etc.) necessary to share the mobile terminal apparatus 2, via a touch screen display 32.

In such a case, the information input or selected by the member J is transmitted to the server 1 via the mobile terminal apparatus 2. Then the server 1 creates new user management information of the member J by associating the information of the member J with a newly issued user ID of the member J, and then associates the newly issued user ID for the member J, as the user ID of the sharing member, with the user ID of the member K.

Next, a procedure of a member changeover process is explained with reference to FIG. 14. FIG. 14 is a flowchart showing the procedure of the member changeover process. Here, the member changeover process means a process implemented to change a member who is a talker in the group talk.

As shown in FIG. 14, when the member changeover process is started, the signal transmission processor 243 of the mobile terminal apparatus 2 determines whether or not a member changeover operation has been performed (a step S801). For example, when receiving operation information indicating that a member changeover button displayed on the touch screen display 32 is touched, the signal transmission processor 243 determines that the member changeover operation has been performed.

When the signal transmission processor 243 determines that the member changeover operation has been performed (Yes in the step S801), the application executing part 24b changes the member who is the talker in the group talk (a step S802). Concretely, the application executing part 24b stores flag information indicating the member as the talker in the group talk among members who are sharing the own apparatus (e.g. the members J and K), in a memory 23, etc., and changes the flag information in accordance with the member changeover operation.

When the flag information indicates, for example, that the member K is the talker, the application executing part 24b transmits talk data including the user ID of the member K to the server 1. Moreover, when the flag information indicates that the member J is the talker, the application executing part 24b transmits the talk data including the user ID of the member J to the server 1.

Then an image generator 241 of each mobile terminal apparatus 2 generates the twittering mark by using the icon image of the member K, when the talk data received from the server 1 includes the user ID of the member K, and generates the twittering mark by using the icon image of the member J, when the talk data received from the server 1 includes the user ID of the member J.

Thus even when one mobile terminal apparatus 2 is shared by the plural members, the other members can easily understand the talker.

When the step S802 is ended or when the member changeover operation has not been performed (No in the step S801), the application executing part 24b ends the member changeover process.

As described above, according to the second embodiment, the other members belonging to the group talk can easily understand that one mobile terminal apparatus 2 is shared by the plural members and that the plural members are in one vehicle. As a result, the fun of the group talk can be enhanced.

In the second embodiment described above, a case where one mobile terminal apparatus 2 is shared by the plural members in one vehicle 70, has been explained as an example. However, the plural members who share the mobile terminal apparatus 2 are not necessarily in the vehicle 70.

The group communication system disclosed in this application is capable of displaying a status in which the plural members are in one vehicle 70. Thus the other members participating in the group talk can understand that the plural members are in the one vehicle 70. A process that identifies a fellow passenger who is also one of the members of the group talk (hereinafter referred to as member fellow passenger) is referred to as a fellow passenger determination process.

The member fellow passenger is identified in the fellow passenger determination process based on a user setting or a setting via the vehicle-mounted apparatus 3. An example of the user setting for the fellow passenger determination process is a process that transmits the user ID, etc. of the member fellow passenger to the server 1 by a user operation. Moreover, an example of the setting via the vehicle-mounted apparatus 3 is a process where the vehicle-mounted apparatus 3 connected with the mobile terminal apparatus 2 transmits an ID of the vehicle-mounted apparatus 3 to the mobile terminal apparatus 2; the mobile terminal apparatus 2 transmits the user ID and the ID of the vehicle-mounted apparatus 3 to the server 1; and the server 1 stores the received data and identifies the member fellow passenger by a matching process using the ID of the vehicle-mounted apparatus 3. When the shared mobile terminal registration process is implemented, the user ID and the ID of the vehicle-mounted apparatus 3 are stored in the server 1. Thus it is possible to identify the member fellow passenger.

### 3. Third Embodiment

In the second embodiment mentioned above, a case where the plural members share one mobile terminal apparatus has been explained. However, shared use of the mobile terminal apparatus is not limited to the case described above, but plural mobile terminal apparatuses may be used as one set. An example of a case where plural mobile terminal apparatuses are treated as one set, is hereinafter explained.

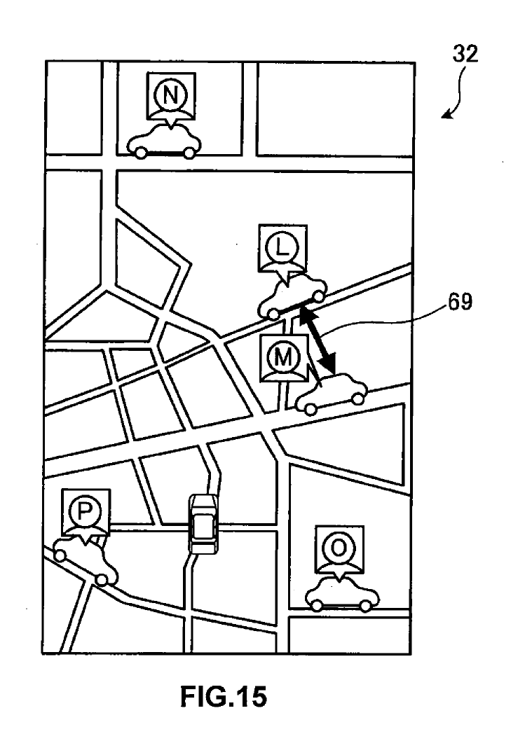

FIG. 15 illustrates an exemplar image of a group selection image in a third embodiment. FIG. 15 illustrates an example where a mobile terminal apparatus 2 of a member L and the mobile terminal apparatus 2 of a member M are treated as one set. Members (here, the members L and M) of which mobile terminal apparatuses are treated as one set are hereinafter referred to as a “members-in-a-set.”

As shown in FIG. 15, in order to show that the member L and the member M are the members-in-a-set, an arrow image 69 connecting the member L with the member M is further superimposed on a map image. As a result, other members of a group talk can easily understand that the members L and M are the members-in-a-set.

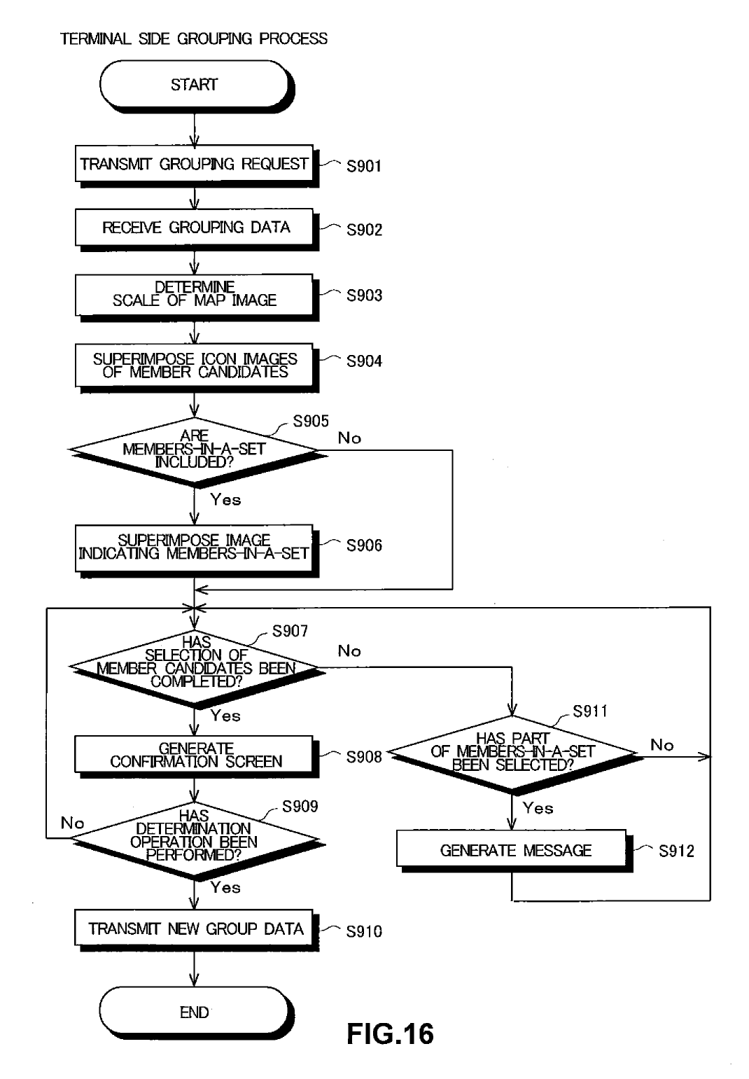

Next explained are concrete operations of the mobile terminal apparatus 2 and a server 1 in the third embodiment. First, a procedure of a terminal side grouping process implemented by the mobile terminal apparatus 2, is explained with reference to FIG. 16. FIG. 16 is a flowchart showing the procedure of the terminal side grouping process.

The grouping process here is not a process for selecting an objective group for which the group talk will be started, from amongst registered candidate groups, but a process for forming a new objective group to start the group talk. The terminal side grouping process is implemented when a grouping mode flag (refer to FIG. 6) is tuned on.

As shown in FIG. 16, when the terminal side grouping process is started, an application executing part 24b of the mobile terminal apparatus 2 transmits a grouping request to the server 1 (a step S901) and receives grouping data from the server 1 (a step S902).

Here, the grouping request is information including a condition (e.g. users who are locating in an area within a 500 meter radius from the own apparatus), etc. for an objective group to be newly formed, in addition to positioning information of the own apparatus. Moreover, the grouping data is information including user management information of a user extracted by the server 1 as a candidate for members (hereinafter referred to as a member candidate) of the newly-formed objective group.

Next, an image generator 241 of the mobile terminal apparatus 2 determines a scale of the map image in accordance with positioning information of each member candidate included in the grouping data received from the server 1 (a step S903), and then superimposes an icon image of each member candidate on the map image (a step S904).

Moreover, the image generator 241 determines whether or not users registered as the members-in-a-set are included in the member candidates (a step S905). When the members-in-a-set are included (Yes in the S905), the image generator 241 further superimposes an image (i.e. the arrow image 69 shown in FIG. 15) indicating the members-in-a-set, on the map image (a step S906).

When the step S906 is ended, or when the members-in-a-set are not included in the step S905 (No in the step S905), the application executing part 24b determines whether or not selection of member candidates who form a new group has been completed (a step S907).

When the application executing part 24b determines that the selection of member candidates who form the new group has been completed in the step S907 (Yes in the step S907), the image generator 241 generates a confirmation screen (a step S908). Thus the generated confirmation screen to confirm that the selected member candidates are correct is displayed on a touch screen display 32.

Next, the application executing part 24b determines whether or not a determination operation has been performed (a step S909). When determining that the determination operation has been performed (Yes in the step S909), the application executing part 24b transmits new group data including user ID of each of the member candidates selected by the user, to the server 1 (a step S910), and then ends the terminal side grouping process. When the determination operation has not been performed (No in the step S909), in other words, when an operation for selecting a member candidate has been performed again, the application executing part 24b returns the process to the step S907.

On the other hand, when the selection of the member candidates has not been completed in the step S907 (No in the step S907), the application executing part 24b determines whether or not an operation for selecting a part of the members-in-a-set has been performed (a step S911). For example, when only the member L registered as the members-in-a-set with the member M is selected, the application executing part 24b determines that the operation for selecting a part of the members-in-a-set has been performed.

The application executing part 24b determines that the operation for selecting a part of the members-in-a-set has been performed in the step S911 (Yes in the step S911), the image generator 241 generates an invalid selection message indicating that the operation for selecting only one of the members-in-a-set is invalid (a step S912). As a result, the invalid selection message is displayed on the touch screen display 32.

When the step S912 is ended, or when the operation for selecting a part of the members-in-a-set has not been performed in the step S911 (No in the step S911), the application executing part 24b returns the process to the step S907.

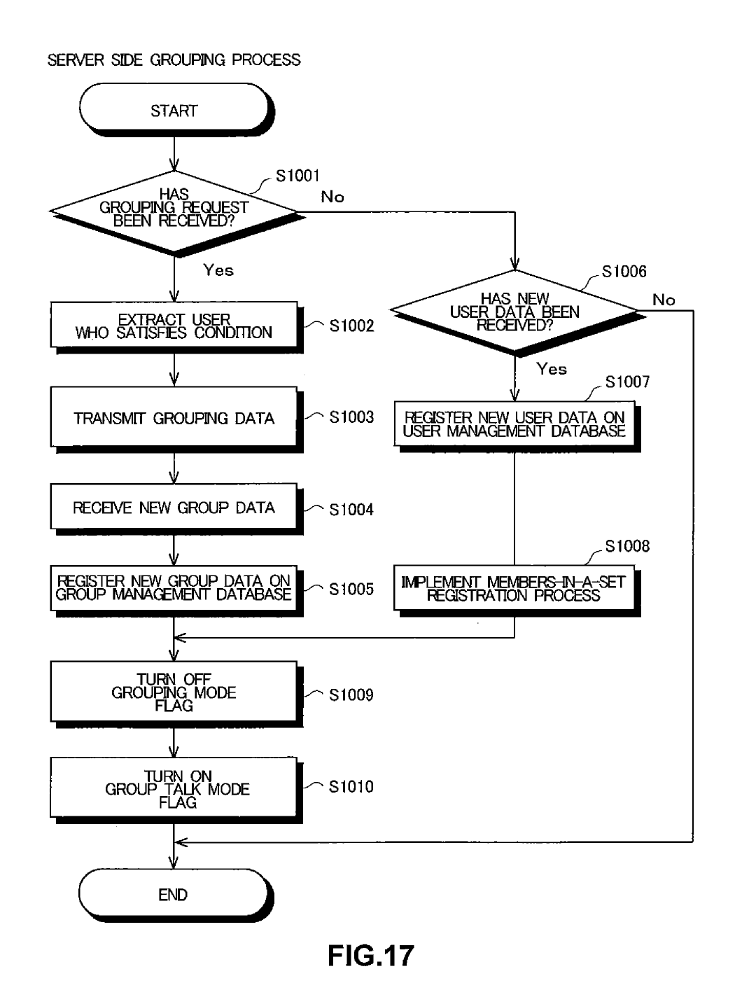

Next, a procedure of a server side grouping process implemented by the server 1 is explained with reference to FIG. 17. FIG. 17 is a flowchart showing the procedure of the server side grouping process. This process is repeated while the server 1 is working.

As shown in FIG. 17, when the server side grouping process is started, the server 1 determines whether or not the server 1 has received the grouping request from the mobile terminal apparatus 2 (a step S1001). When determining that the server 1 has received the grouping request in the step S1001 (Yes in the step S1001), the server 1 extracts, based on the received grouping request, a user who satisfies the condition for the objective group, from a user management database 11a (a step S1002).

For example, in a case where the condition for the objective group is “users who are locating in an area within a 500 meter radius from the own apparatus,” the server 1 identifies one or more users locating in the area within a 500 meter radius from a location indicated by the positioning information, by using the positioning information included in the grouping request, and then extracts the user management information of the identified a user from the user management database 11a. Then the server 1 transmits the grouping data including the user management information of the user who satisfies the condition, to the mobile terminal apparatus 2 (a step S1003).

Next, when receiving the new group data from the mobile terminal apparatus 2 (a step S1004), the server 1 registers the received new group data on the group management database 11b (a step S1005).

On the other hand, when having not received the grouping request in the step S1001 (No in the step S1001), the server 1 determines whether or not the server 1 has received new user data from the mobile terminal apparatus 2 (a step S1006). When determining that the server 1 has received the new user data (Yes in the step S1006), the server 1 registers the received new user data on the user management database 11a (a step S1007).

Moreover, when the new user data includes a members-in-a-set registration request, the server 1 implements a members-in-a-set registration process (a step S1008). The “members-in-a-set” registration request includes, for example, a user ID of a current member to be the members-in-a-set of a new user. The server 1 newly adds a “members-in-a-set” item to the user management information of the current user, and stores the user ID of the new user in the members-in-a-set item. Similarly, the server 1 newly adds a “members-in-a-set” item to user management information of the new user, and stores the user ID of the current user in the “members-in-a-set” item.

When the step S1005 or the step S1008 is ended, the server 1 turns off the grouping mode flag (a step S1009), and turns on a group talk mode flag (a step S1010), and then ends the server side grouping process. Moreover, the server 1 also ends the server side grouping process when having not received the new user data in the step S1006 (No in the step S1006).

As described above, according to the third embodiment, the fun of the group talk can be enhanced by treating plural mobile terminal apparatuses 2 as one set.

### 4. Modifications

In the embodiments described above, cases where the server 1 communicates with the mobile terminal apparatus 2 have been explained. However, a vehicle-mounted apparatus 3 may communicate with a server 1. Moreover, in the embodiments described above, cases where the mobile terminal apparatus 2 includes the navigation function, have been explained. However, a vehicle-mounted apparatus 3 may include a navigation function.

Furthermore, in the embodiments mentioned above, cases where the group communication system 100 includes the server 1, the mobile terminal apparatus 2, and the vehicle-mounted apparatus 3, have been explained. However, the configuration of the group communication system 100 is not limited to the cases. For examples, a group communication system may include a server and a vehicle-mounted apparatus but may not include a mobile terminal apparatus. In such a case, the vehicle-mounted apparatus may include the positioning information acquisition part 22, the memory 23, the application executing part 24b and the navigation part 24c shown in FIG. 3.

In addition, a group communication system may include a server and a mobile terminal apparatus, but may not include a vehicle-mounted apparatus. In such a case, the mobile terminal apparatus may include the operation information transmitter 34b, the display controller 34c, the voice output controller 34d, the voice recognition processor 34e, and the execution instruction part 34f shown in FIG. 3.

Furthermore, a group communication system may include two servers of an emergency reporting server and a group talk server. In such a case, an operation similar to the server 1 shown in FIG. 1 may be performed by a cooperative work between the emergency reporting server and the group talk server.

As mentioned above, the technology described above is useful for when a user desires to decide whether or not to participate in a group talk after understanding of locations of members of the group talk. The technology is especially applicable to vehicle-mounted apparatuses or vehicle-mounted systems.

While the invention has been shown and described in detail, the foregoing description is in all aspects illustrative and not restrictive. It is therefore understood that numerous other modifications and variations can be devised without departing from the scope of the invention.

What is claimed is:

1. A terminal apparatus comprising:
a communication part that implements, via a server apparatus, group communication that is communication among members belonging to a same group; and
an image generator that generates a group selection image used for selecting an objective group for which the group communication is implemented,
wherein the group selection image includes:
a selection candidate image indicating one or more candidate groups that are selection candidates for the objective group; and
a location image including a map image and an icon image indicating a member belonging to one candidate group among the one or more candidate groups, at a location corresponding to positioning information of the member, on the map image.

2. The terminal apparatus according to claim 1, wherein
the location image includes the icon image of the member belonging to one candidate group temporarily selected by a user, from amongst the one or more candidate groups.

3. The terminal apparatus according to claim 1, further comprising
an instruction part that, when the objective group is selected from amongst the one or more candidate groups, instructs the server apparatus to start the group communication for the selected objective group.

4. The terminal apparatus according to claim 3, wherein
the image generator generates an image indicating a location where a member belonging to the objective group transmits communication data relating to the group communication, when the objective group is selected from amongst the one or more candidate groups.

5. The terminal apparatus according to claim 1, wherein
the one or more candidate groups included in the selection candidate image is disposed in a direction intersecting a direction in which the selection candidate image and the location image are disposed.

6. The terminal apparatus according to claim 1, wherein
the location image includes the icon image of the member belonging to one candidate group shown in a particular area in the selection candidate image among the one or more candidate groups shown in the selection candidate image.

7. The terminal apparatus according to claim 1, wherein
the image generator determines a scale of the map image included in the location image, based on the positioning information of the member belonging to the one candidate group.

8. The terminal apparatus according to claim 1, wherein
the scale of the map image included in the location image is fixed; and
wherein the group selection image further includes
if there is a particular member who belongs to the one candidate group and who is not located within a range of the map image included in the location image, an icon image indicating the particular member outside the selection candidate image and the location image.

9. The terminal apparatus according to claim 1, wherein
the location image includes a route of the member belonging to the one candidate group.

10. The terminal apparatus according to claim 1, further comprising
a transmitter that transmits an image generated by the image generator, to an information displaying apparatus used in a vehicle, and that causes the information displaying apparatus to display the transmitted image.

11. A terminal apparatus that implements, via a server apparatus, group communication that is communication among members belonging to a same group, the terminal apparatus comprising:
a first display controller that displays, on a display, a list of one or more candidate groups that are selection candidates for an objective group for which the group communication is implemented;
a second display controller that displays, on the display, a map image including an icon image indicating a location of a member belonging to one candidate group temporarily selected by a user, from amongst the one or more candidate groups; and
an instruction part that, when the objective group is selected from amongst the one or more candidate groups, instructs the server apparatus to start the group communication for the selected objective group.

12. An information displaying apparatus comprising:
a receiver that receives a group selection image used for selecting an objective group for which group communication that is communication among members belonging to a same group is implemented; and
a display that displays the group selection image received by the receiver,
wherein the group selection image includes:
a selection candidate image indicating one or more candidate groups that are selection candidates for the objective group; and
a location image including a map image and an icon image indicating a member belonging to one candidate group among the one or more candidate groups, at a location corresponding to positioning information of the member, on the map image.

13. An information displaying apparatus comprising:
a first display that displays a list of one or more candidate groups that are selection candidates for an objective group for which group communication that is communication among members belonging to a same group is implemented;
a second display that displays a map image including an icon image indicating a location of a member belonging to one candidate group temporarily selected by a user, from amongst the one or more candidate groups; and
a receiving part that receives an operation of the user for selecting the objective group from amongst the one or more candidate groups.

14. A communication system that is used for group communication that is communication among members belonging to a same group, the communication system comprising:
a server apparatus; and
a plurality of terminal apparatuses communicable with the server apparatus,
wherein the server apparatus includes:
a memory that stores positioning information acquired from the plurality of terminal apparatuses; and
a transmitter that transmits the positioning information stored in the memory, to each of the plurality of terminal apparatuses,
wherein each of the plurality of terminal apparatuses includes
an image generator that generates a group selection image used for selecting an objective group for which the group communication is implemented, based on the positioning information received from the server apparatus; and
wherein the group selection image includes;
a selection candidate image indicating one or more candidate groups that are selection candidates for the objective group; and
a location image including a map image and an icon image indicating a member belonging to one candidate group among the one or more candidate groups, at a location corresponding to positioning information of the member, on the map image.

15. A communication system that is used for group communication that is communication among members belonging to a same group, the communication system comprising:
a server apparatus; and
a plurality of terminal apparatuses communicable with the server apparatus,
wherein the server apparatus includes:
a memory that stores positioning information acquired from the plurality of terminal apparatuses; and
a transmitter that transmits the positioning information stored in the memory, to each of the plurality of terminal apparatuses, and
wherein each of the plurality of terminal apparatuses includes:
a first display controller that displays, on a display, a list of one or more candidate groups that are selection candidates for an objective group for which the group communication is implemented;
a second display controller that displays, on the display, a map image including an icon image indicating a member belonging to one candidate group temporarily selected by a user, from amongst the one or more candidate groups; and
an instruction part that, when the objective group is selected from amongst the one or more candidate groups, instructs the server apparatus to start the group communication for the selected objective group.
